(19) United States
(12) Patent Application Publication
(10) Pub. No.: US 2024/0286298 A1
(43) Pub. Date: Aug. 29, 2024

(54) Novel Deformable Mechanism For Robotic Propulsion, Manipulation And Other Devices

(71) Applicant: The Trustees of Columbia University in the City of New York, New York, NY (US)

(72) Inventors: Zechen Xiong, New York, NY (US); Hod Lipson, Fort Lee, NJ (US)

(21) Appl. No.: 18/430,804

(22) Filed: Feb. 2, 2024

Related U.S. Application Data
(60) Provisional application No. 63/443,017, filed on Feb. 2, 2023.
(60) Provisional application No. 63/580,050, filed on Sep. 1, 2023.

(51) Int. Cl. B25J 18/04; B25J 11/00; B25J 17/02

(52) U.S. Cl. CPC B25J 18/04; B25J 11/00; B25J 17/0208

(57) ABSTRACT

A bistable component, including: a ribbon comprising (i) a first extension arm having a proximal portion and a distal portion, (ii) a second extension arm having a proximal portion and a distal portion, and (iii) a central segment connecting the proximal portion of the first extension arm and the proximal portion of the second extension arm, the distal portion of the first extension arm being joined to the distal portion of the second extension arm at a joint, the bistable component being reversibly convertible between a stable stressed first state and a stable stressed second state, the central segment having (i) a first curvature state corresponding to the bistable component being in the stable stressed first state and (ii) a second curvature state corresponding to the bistable component being in the stable stressed second state.

### CROSS-REFERENCE TO RELATED APPLICATIONS

This application claims priority to and the benefit of U.S. Provisional Application No. 63/443,017, “Novel Deformable Mechanism for Robotic Propulsion, Manipulation And Other Devices” (filed Feb. 2, 2023), and U.S. Provisional Application No. 63/580,050, “Novel Deformable Mechanism for Robotic Propulsion, Manipulation And Other Devices” (filed Sep. 1, 2023). All foregoing applications are incorporated herein by reference in their entireties for any and all purposes.

### TECHNICAL FIELD

The present disclosure relates to the field of deformable materials.

### BACKGROUND

Soft robots and manipulators offer many advantages compared to traditional robots, such as bio-compatibility, safety, resilience, and economic viability. These features have gained them an important role in a broad range of potential applications. Drawing from the observation that most biological lifeforms have compliant bodies, soft robots use deformable and resilient material for both their torso and limbs. Popular materials like dielectric elastomer (DE), silicone rubber, and PDMS all have moduli of 10-1000 kPa and a density slightly over 1 g/cm3, which are similar to those of human muscles. However, the high mass density and low energy density of these elastomers severely limit the speed and strength of soft robots. Accordingly, there is a long-felt need in the art for improved soft robot component.

### SUMMARY

In meeting these long-felt needs, the present disclosure provides a bistable component, comprising: a ribbon comprising (i) a first extension arm having a proximal portion and a distal portion, (ii) a second extension arm having a proximal portion and a distal portion, and (iii) a central segment connecting the proximal portion of the first extension arm and the proximal portion of the second extension arm, the distal portion of the first extension arm being joined to the distal portion of the second extension arm at a joint, the bistable component being reversibly convertible between a stable stressed first state and a stable stressed second state, the central segment having (i) a first curvature state corresponding to the bistable component being in the stable stressed first state and (ii) a second curvature state corresponding to the bistable component being in the stable stressed second state, and inversion of the central segment from one of the first curvature state and the second curvature state to the other of the first curvature state and the second curvature state effecting conversion of the bistable component from the respective one of the first stressed stable state and the second stressed stable state to the other of the first stressed stable state and the second stressed stable state.

Robot grasping is subject to an inherent tradeoff: Grippers with a large span typically take a longer time to close, and fast grippers usually cover a small span. However, many practical applications of grippers require the ability to close a large distance rapidly. For example, grasping cloth typically requires pressing a wide span of fabric into a graspable cusp. To address these challenges, we propose to use the prestressed bi-stable hair-clip mechanisms (HCM) as end effectors for robotic manipulation.

Here, we demonstrate a human-finger-inspired snapping gripper that exploits elastic instability to achieve rapid and reversible closing over a wide span. In one example, non-limiting embodiment and using prestressed semi-rigid material as the skeleton, the gripper fingers can widely open (86 mm) and rapidly close (46 ms) following a trajectory similar to that of a thumb-index finger pinching, and is 2.7 times and 10.9 times better than a reference gripper in terms of span and speed, respectively.

In meeting the long-felt needs in the field, the present disclosure provides a bistable component, comprising: a ribbon comprising (i) a first extension arm having a proximal portion and a distal portion, (ii) a second extension arm having a proximal portion and a distal portion, and (iii) a central segment connecting the proximal portion of the first extension arm and the proximal portion of the second extension arm, the distal portion of the first extension arm being joined to the distal portion of the second extension arm at a joint, the bistable component being reversibly convertible between a stable stressed first state and a stable stressed second state, the central segment having (i) a first curvature state corresponding to the bistable component being in the stable stressed first state and (ii) a second curvature state corresponding to the bistable component being in the stable stressed second state, and inversion of the central segment from one of the first curvature state and the second curvature state to the other of the first curvature state and the second curvature state effecting conversion of the bistable component from the respective one of the first stressed stable state and the second stressed stable state to the other of the first stressed stable state and the second stressed stable state.

Also provided is a system, the system comprising a bistable component according to the present disclosure (e.g., according to any one of Aspects 1-5) and an actuator, the actuator configured to effect inversion of the central segment from one of the first curvature state and the second curvature state to the other of the first curvature state and the second curvature state.

Further provided is a method, comprising effecting conversion of a bistable component according to the present disclosure (e.g., according to any one of Aspects 1-5) between one of the stable stressed first state and the stable stressed second state and the other of the stable stressed first state and the stable stressed second state.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document.

FIG. 1 shows a comparison of locomotion speed between our proposed hair-clip mechanism (HCM) biped robot and other reported untethered locomotive soft robots. Technologies used include dielectric elastomer (DE), pneu-nets, SMA, ion elecroactive polymer (IEAP), isoperimetric shape change.

FIG. 2 shows a comparison of swimming velocity with respect to actuation frequency among HCM-driven and various reported soft robotic swimmers. The hollow circles in the figure denote tethered swimmers and solid circles denote untethered swimmers.

FIG. 3 shows bistable hair-clip mechanisms (HCMs) as fingers for a universal soft gripper. (A) The geometry of an HCM finger and its morphology upon assemble. Parameters H is ribbon width, D is the prestressing distance, l is the effective half length of the ribbon, and u(1) is the lateral defection of the HCM mechanism at z=1. (B) The HCM fingers installed on a commercial robotic arm for picking up a variety of 2D and 3D objects. The HCM gripper performs thumb-index finger pinching on (C) a t-shirt (front view), (D) a dollar coin (bottom view), and (E) a tomato. The wrinkles or cusp of the t-shirt indicate the different picking-up mechanism for 2D limp objects. Insets show the pinching motion of a human hand for comparison. (F) Holding force vs, dimension for a wide range of 2D and 3D objects when prestressing level D=40 cm. The left region includes 3D geometric shapes ordered by dimensions and right region shows limp 2D objects including a piece of linen cloth and a t-shirt. The dollar coin has a diameter of 26.5 mm, and can be used for size comparison for the rigid objects. The coin, the thin disc, and the t-shirt have a low picking-up reliability of 40%, 50%, and 50% based on 10 trials, respectively, due to their shapes or self-weight, while others have a success rate of 100%.

FIG. 4 shows differences in criteria for picking up 2D and 3D objects. (A) Force analysis of the thumb-index finger grasping of limp objects. (B) Requirements of picking up 2D and 3D objects. The blue region is for 2D objects and the yellow region is for 3D objects.

FIG. 5 shows key properties of the HCM grippers. (A) Holding forces of different fabric and leather samples w.r.t the prestressing level D. (B) The gripper span W vs. prestressing level D in normal and 10°-tilt situations compared to the span of the traditional gripper. (C) The comparison of dynamics between the HCM gripper and the traditional one. The HCM gripper with D=20 cm and a 10° inward tilt of the fingers can snap in 45.8±6.7 ms and cover a span of 86 mm, while the traditional finger covers a span of 32 mm in 0.5 s.

FIG. 6 shows fatigue lives of HCM fingers (D=20 mm) made of PETG plastic sheets with thickness t=0.015-0.06 inch. The inset shows the development of crackings at the corners of a plastic HCM finger with t=0.06 inch.

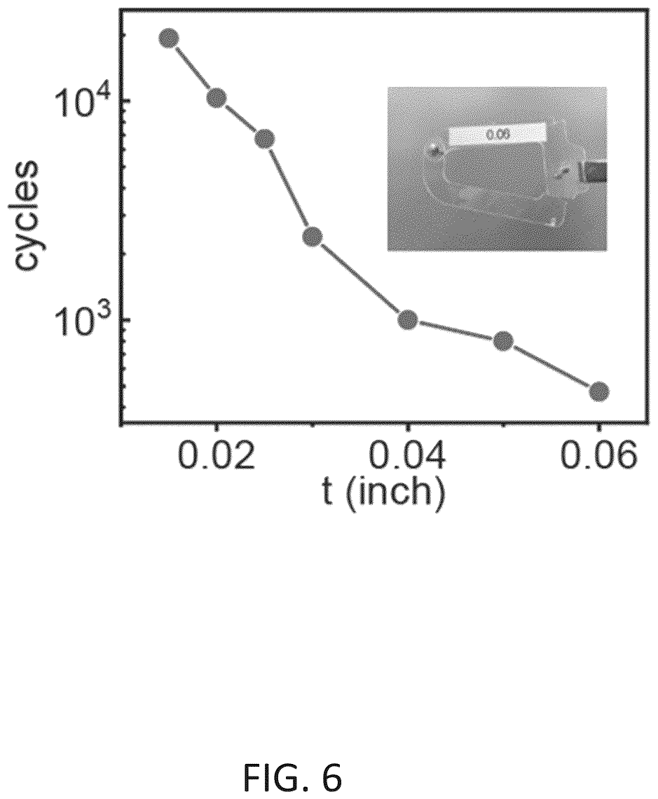

FIG. 7 Manipulating fabric with the motor-driven and the pneumatic HCM grippers. (A) and (B) The process of picking up an initially flat cotton fabric sheet with the motor-driven HCM gripper. The HCM fingers have D=20 mm, W=86 mm, and an inward tilting angle of 10° to increase the grasping force. (C) The failure of the traditional gripper to manipulate limp materials due to a small span. (D) and (E) The process of pneumatic HCM fingers picking up an initially flat fabric upon an actuation pressure of ˜150 kPa. The plastic has a thickness of t=0.381 mm. (F) Pneumatic HCM gripper is able to pick up a roll of tape (44 g), which is three times its self-weight (15 g).

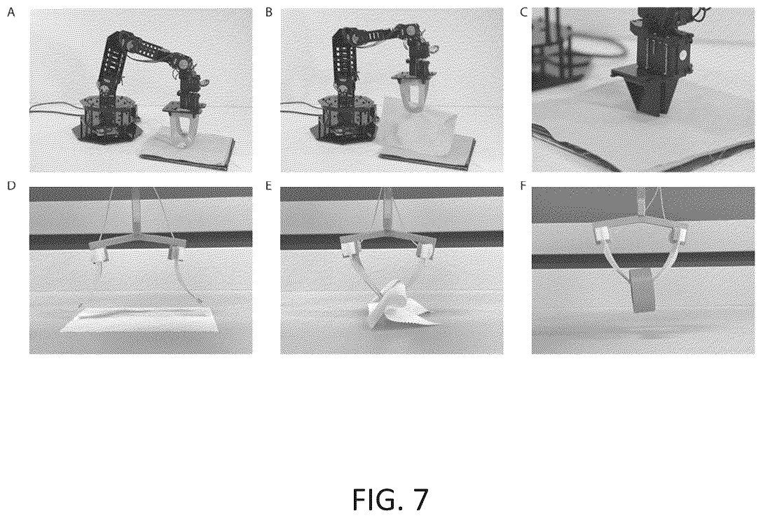

FIG. 8 shows working principle, mathematical model, and soft robotic applications of the hair-clip mechanism (HCM). (A) The configuration of a steel hair clip before and after assembly. (B) and (C) The assembly of a typical HCM. (D)-(F) The mathematical modeling of the hair clip mechanism (HCM). The coordinate z is defined as the equivalent length of the half ribbon. (G) The energy landscape of bistable HCM. (H) The fish robots with HCM as fish body and tail.

FIG. 9 shows validation of the variable φ using Abaqus FE simulation. (A) The physical meaning of Bessel function J_{1/4} and its map to rotation angle φ. (B) and (C) The FE method simulation of HCM with shape factor θ=10, γₛ=L₂/L₁=6, and other parameters h/L₁=15 mm/12.5 mm and +/L₁=0.381 mm/12.5 mm. (C) Comparison of the theoretical calculation and FE simulated value of φ.

FIG. 10 shows a designing algorithm of servo-HCM robotic systems based on HCM theory of Eq. (16)-(20). The design factor α is assumed to be 1.0 in our cases.

FIG. 11 shows the influence of materials and dimensions to the actuation torque T_{act, HCM} and the design frequency f_{design}. (A)-(C) The T_{act, HCM} profile w.r.t half ribbon l and prestressing distance D of PETG plastic sheets, CFRP sheets, and steel sheets, respectively. The T_{act, HCM} is found to be proportional to D, b³, and h, but is less affected by l. Actual prototypes are pinpointed in the profiles for comparison and verification. (D) The design frequency f_{design} calculation of different materials, geometry, and servos. Bothe the left and right fish robots are limited by the speed of the servos.

FIG. 12 shows a Hair-clip mechanism (HCM) compliant fish robots. (A) The side view of CarbonFish. Components include 0.5 mm CFRP plates, PETG plastic film, onboard 7.6V Li-po battery pack, Arduino Nano 33, A66BHLW waterproof servo motor, and a variety of mechanical fasters (screws, nuts, spacers, non-slip nuts, etc.). (B) The front view of CarbonFish. (C) The exploded view of CarbonFish.

FIG. 13 shows principle, modeling, and prototypes of HCM soft robotics. Adapted from Xiong et al. (A) A steel hair clip before and after assembly. (B) and (C) The characterization and assembly of a typical HCM. (D)-(F) The mathematical modeling of the hair clip mechanism (HCM). Coordinate z is defined as the straightened coordinate of the half ribbon. (G) The energy landscape of a paper HCM. (H) HCM fish robots from the previous studies.

FIG. 14 shows a designing algorithm of servo-HCM robotic systems based on HCM theory of Eq. (16)-(20). The design factor α is assumed to be 1.0 in our cases.

FIG. 15 shows influence of materials and dimensions on the actuation torque T_{act, HCM}, and the design frequency f_{design}. (A)-(C) The T_{act, HCM} profile w.r.t geometric parameters (1, D, t, h, L₂/L₁) for materials of PETG plastic sheets, CFRP sheets, and steel sheets, respectively. The T_{act, HCM} is found to be proportional to D, t³, and h but is less affected by l. Actual prototypes are embedded in the surface plots for comparison and validation. (D) The design frequency capacity f_{design} calculation for different materials, geometry, and servos. Both the coral fish and CarbonFish are limited by the speed of the servos.

FIG. 16 shows photos of CarbonFish. (A) Individual components of CarbonFish. (B) Side view and dimensions of CarbonFish. (C) Bottom view and dimensions of CarbonFish. Parameters H_{body}=100 mm, H_{fin}=140 mm, L_{standard}=170 mm, L_{fork}=232 mm, Lₜₒₜₐₗ=270 mm, W_{body}=21 mm, and u(l)=25 mm≈u′(l).

FIG. 17 shows comparison between HCM fish robots and existent fish robots from literature. (A) The speed comparison in body length per second (BL/s). (B) The speed comparison in body length per beat (BL/beat).

FIG. 18 shows a comparison of the HCM swimming pattern of a pneumatic fish robot and that of a traditional reference. Adapted from [2]. (A) Constitution of the HCM fish robot, i, caudal fin (plastic film with thickness+=0.191 mm), ii, rivet pin, iii. HCM (plastic film with t=0.381 mm), iv, antagonistic pneumatic bending units, v. 3D-printed hollow fish head, vi, mass center of the assembly, and vii, cast ballast. (B) Velocity comparison in an aquarium. Scale bar, 150 mm. (C) Angular displacement ψ₁ w.r.t the forward direction of the two models at the caudal peduncle (rivet pin spot). Both cases use actuation pressure of 150 kPa and frequency of 1.3 Hz (period=760 ms). Grey areas of channel 1 and channel 2 show the duty cycles (150 ms/380 ms) of actuation in both cases. The red and blue areas show the range of ψₗ in both cases.

FIG. 19 shows a single-link simulation in Aquarium to reproduce the HCM effect. (A) The setup of the simulation. I=12 cm, which is the body and caudal fin length of the fish robots. (B) The smoothed HCM undulation, the smoothed reference robot undulation (generated from smoothing plots in FIG. 1C), the curve-fit sine wave, and the cambering sine wave as the input signals of the swinging link in the search of the best water-propelling pattern. (C) and (D) The angular velocity and angular acceleration of the four undulation patterns.

FIG. 20 shows results of the single-link water-propelling simulation. (A) The link swings to generate a left-ward hydraulic thrust. The color is the vorticity. (B) The thrust from the four difference undulation patterns during a passage of four cycles (3 s). (C) The plots of thrust and acceleration indicate a correlation between them two. (D) The torque exerted on the link. (E) The input power of the single-link model, obtained from torque times angular velocity. Negative points are removed to calculate energy efficiencies, since the robots cannot harvest energy. (F) The normalized values of average thrust, average power, and energy efficiencies of the four patterns. HCM undulation gets an average thrust of 16.7 N/m, 2-3 times larger than the reference undulation (6.78 N/m), sine pattern (5.34 N/m), and cambering sine pattern (6.36 N/m), and has a normalized efficiency of 0.87 (0.256 N/W), juxtaposed with efficiencies of 0.90 of the reference wave, 1.00 of the sine wave, and 0.37 of the cambering sine wave.

FIG. 21 shows traced swimming sequences and the sampling methodology for the multi-link simulation. (A) and (B) The robotic configuration evolution of the HCM and reference swimming. (C) The methodology of extracting the three-link model variables from the swimming videos or sequences.

FIG. 22 shows sampled variable profiles of HCM and reference undulations from the experiments. (A) and (B) The variable plots in a half cycle (˜400 ms) of the HCM robot. Nonlinearities like skewness, asymmetry, and cambering-ness are observed in the posterior portion of the HCM fish. (C) and (D). The variables of the reference robot.

### DETAILED DESCRIPTION OF ILLUSTRATIVE EMBODIMENTS

The present disclosure may be understood more readily by reference to the following detailed description of desired embodiments and the examples included therein.

Manuscript 1: Fast Untethered Soft Robotic Crawler with Elastic Instability

### Introduction

Soft robots and manipulators offer many advantages compared to traditional robots, such as bio-compatibility, safety, resilience, and economic viability. These features have gained them an important role in a broad range of potential applications. Drawing from the observation that most biological lifeforms have compliant bodies, soft robots use deformable and resilient material for both their torso and limbs. Popular materials like dielectric elastomer (DE), silicone rubber, and PDMS all have moduli of 10-1000 kPa and a density slightly over 1 g/cm³, which are similar to those of human muscles. However, the high mass density and low energy density of these elastomers severely limit the speed and strength of soft robots.

To overcome the speed and force problem, researchers have proposed several solutions. Mosadegn et al, and Bas et al, suggest using improved geometry of the pneumatic network (pneu-net) to reduce the amount of gas needed for its inflation so that its response can be expedited. Such a proposal enables a fast actuation of tens of milliseconds yet at the cost of higher actuation pressure or energy source. Shepherd et al., Bartlett et al., Tolley et al., and Keithly et al. use explosive reactions in pneumatic networks to power jumping soft robots. This method generates fast and large leaps but is hard to iterate and control, and may cause damage to the matrix materials. Li et al, and Wu et al. use high-frequency electric power to drive fast-moving fish and terrestrial robot, but this process demand extra energy input, making it hard to remove the tether. Lin et al, design a rolling caterpillar robot driven by a shape memory alloy (SMA) actuator, which moves at a speed exceeding 0.5 m/s. Yet the robot lacks the ability to work continuously. Wang et al, create a flower-shaped tiny magnetic soft robot that can wrap a living fly in 35 ms and deform at high frequencies, but its working range is limited by the powering magnetic fields. Another solution is to use structural instability as a force amplifier to create rapid and strong soft robots, yet the reported techniques are restricted by the design and fabrication methods, impeding their practical use, especially in the untethered robotic field.

Inspired by the fact that most fast-moving animals have rigid body parts like spine and bones to support and build moving gaits, we investigate the potential of using semi-rigid materials, i.e., materials that are generally rigid enough to support weights yet can deform considerably at the same time, to create unique moving gait for untethered soft robots. Borrowing from the snap-through mechanism of a steel hair clip, we proposed a new strategy of using the in-plane prestressing of 2D materials like plastic shims and metal sheets to create bi-stable and multi-stable mechanisms. An example of this phenomenon can be illustrated by pinning the two extremities of an angled plastic ribbon together, to obtain a hair-clip-like bi-stable mechanism that can be used for the propulsion of a fish robot (e.g., swimming at 436 mm/s or 2.03 BL/s); if two such hair-clip mechanisms (HCM) are joined head-to-head, a quadri-stable compliant structure can then be assembled from 2D materials with the strategy of in-plane pre-stressing. To make the system simpler and more controllable for the untethered biped robot, we have the two HCMs in its chassis as symmetric as possible and treat it as a bi-stable mechanism. In this way, the HCM biped robot can switch between two states—flexion and extension—through mechanic actuation, which is achieved by a single servo in our case, and can perform a biomimetic galloping like a cheetah or a wolf does. On the other hand, if we make the two HCMs slightly different and actuate them separately, a completely different locomotion gait can be triggered. This is discussed in more detail below.

Experiments show such an untethered HCM biped soft robot with a single mini servo as actuation can locomote at a record-breaking speed of 1.56 BL/s (313 mm/s), increasing drastically from previous untethered soft robots. The rest of this paper would be organized as follows. We first introduce the working principle of the HCM, giving the theoretic solutions to the deformation and energy properties in the processes of assembly and buckling. Then we elaborate on the materials, designs, and fabrication procedures for the untether biped robots. After that, we describe the application of HCMs in an untether and a tether soft robot and compare it to existing studies.

### Working Principles

The fast morphing and force amplifying effect of the HCM are from the snap-through buckling of bi- and multi-stable structures. It is observed that the lateral-torsional buckling of the ribbons when pinning the extremities together would lock the structure into a dome-like configuration with increased rigidity and bi-stability, which explains the functions of the HCM as a load-bearing skeleton and a high-speed actuator. Using the knowledge from the beam buckling model and previous studies, it is believed that the theoretic buckling shape can be given as:

$$φ = \sqrt{l - z} {A}_{1} {J}_{1 / 4} ( \frac{1}{2} \sqrt{\frac{{P}_{cr}^{2}}{E {I}_{η} C}} {( l - z )}^{2} ) , \qquad ( 1 )$$

in which φ is the lateral rotational angle, A₁ is a non-zero integration constant that can be determined from energy conservation, J_{1/4} is the Bessel equation of order ¼, indicating that the ribbons buckle in the shape of a Bessel equation theoretically during the assemble, Pₑᵣ is the critical load of the lateral-torsional buckling of the ribbon, EI_{η}=Eh³t/12 is the out-of-plane bending stiffness of the ribbon, C=Ght³/3 is the torsional rigidity of the rectangular-section ribbon, E is Young's modulus, G is the shear modulus of the sheet material, h is the ribbon width and t is the thickness of the sheet. Plugging in the boundary condition of the assemble HCM, the value of the Pₑᵣ can be derived as:

$${P}_{cr} = \frac{5.5618}{{l}^{2}} \cdot \sqrt{E {I}_{η} C} . \qquad ( 2 )$$

The three most significant factors that influence the kinematic and dynamic features of these HCM structures are the tip bending angle ψ₁, the energy barrier U_{barr}, and the timescale t* of the snap-through process, which can be expressed as following respectively, according to the theory,

$${ψ}_{l} = \frac{{P}_{cr}}{{EI}_{η}} {\int }_{0}^{l} φ ( l - z ) dz , \qquad ( 3 )$$

$${U}_{barr} = 3 {P}_{cr} \cdot D , \qquad ( 4 )$$

$$and$$

$${t}_{*} = \frac{{( 2 l )}^{2}}{t \sqrt{E / {ρ}_{s}}} , \qquad ( 5 )$$

where ρₛ is the density of the material.

The measured value of ψₗ and U_{barr} in the case of l=129.1 mm and D=16 mm are 0.44 rad and 43.4 mJ, and the theory gives corresponding values of 0.53 rad and 28.2 mJ, which are 20% and −35% in error compared with the experiments. The considerable error is due to the angled shape of the ribbons that deviates from an encastred beam used to develop the theory and the path dependency and friction effect that make the measured energy barrier larger than the theory.

The design factors l and D are extracted to show how we can configure the energy and kinematic property to optimize the robotic performance. It is observed that increasing the half ribbon length l will decrease both the tip bending angle ψ₁ and the energy barrier U_{barr}, thus decreasing both the foot swinging amplitude in the galloping gait and the energy released in each swinging, leading to reduced mobility of the biped robot; on the other hand, increasing the locking displacement D will result in the opposite effects. Obviously, increasing the energy barrier of the HCM chassis of the robot would require some stronger yet larger and heavier servo motor for its actuation, making the designing process a trade-off.

Thin plastic plates are generally too compliant to work as chassis and support the weight of a robot. Yet with the technique of HCM, we manage to elevate the rigidity by in-plane prestressing. The unassemble plastic HCM chassis has a constant rigidity of K₁=0.0205±0.0006 N/mm, while the assembled HCM chassis has an equivalent rigidity of K₂=0.2186±0.0066 N/mm in the bi-stable direction and constant rigidity K₃=0.0848=0.0082 N/mm in the mono-stable direction, which are about 11 times and 4 times larger, respectively than the unassembled one. With a self-weight of 72 g of our self-contained robot, ignoring the mass distribution, the static deflections will be 34 mm, 3.2 mm, and 8.3 mm in these three scenarios, respectively, showing the rigidity advantage of the HCMs.

Another trait of the dual-HCM chassis is that the two HCMs in the structure can be tuned and actuated separately based on the theory illustrated above, thus creating more special gaits other than the gallop. Essentially, the dual-HCM chassis is a quadri-stable structure, and depending on dimensions like l's and D's of the two HCM, we can make it to be symmetric quadri-stable or asymmetric quadri-stable. The experiments based on this technique are discussed in more detail below.

### Fabrication and Measurements

The dual-HCM untethered bi-stable biped soft robot is composed of various parts (for clarity, we refer to the untethered HCM robot as a bi-stable robot instead of a quadri-stable robot), including a laser-cut (Thunder Laser, Nova51) PETG plastic HCM spine (McMaster-Carr, 9536K) that also works as the chassis, an Arduino nano microcontroller board, an MG90s servo motor, a 3D-printed horn (Ultimaker S3, PLA) that connects the servo with the links to actuate the bi-stable HCM, a 3D-printed battery holder, a battery set with two 3.7 V and 350 mAh Li-ion cylindrical cells (AA Portable Power Corp., LC-10440, AAA size), two press-fit rivets (McMaster-Carr, 97362A), a few M2 screws and Nylock nuts, and four 3D-printed feet with silicone rubber (Smooth-On Inc., Ecoflex 10) glued to them (using Loctite Super Glue), which will be further discussed below.

We use semi-rigid material PETG plastic sheets to fabricate HCMs (Young's modulus E=1730 MPa) to develop the force-amplifying spine and supporting chassis of the bi-stable robot. Although not as soft as the classic soft materials like silicone rubber, HCMs preserve the most important features of soft robots—easy to design and fabricate, safe for humans, resilient to harsh conditions, and a continuum body that has infinite degrees of freedom.

Like the galloping of animals in nature, the forward marching of the robot requires anisotropic friction force. Since our single-servo and single-joint biped robot does not have sophisticated feet and soles, we employ a simple way of creating forward friction: the feet of the robot are made of half plastic and half rubber. The friction coefficients on clean and smooth surfaces like wood and glass and coarse surfaces like marble floor and concrete surface are measured through dragging test and the difference of the two kinds of contact are explored. All averaged values and standard deviations are calculated from 5 measurements. The silicone rubber pads offer a 140%˜400% increase in friction according to our measurements. To make the robot more stable in the lateral direction during locomotion, the feet are designed to have a thickening shape.

The measurement of robotic speed and displacement is carried out using videos by comparing the covered distance to the dimension of the robot itself. The tip bending angles are measured from pictures. The rigidity of the assembled HCM plate and the unassembled plastic plate are measured using a 3-point bending test with a span of 18 cm (SUNS, UTM4000 tensile machine). The energy barrier of an assembled dual-HCM plate is calculated from the area under the load-displacement curve. Both the rigidity and the energy barrier value are averages of 6 measurements, including 3 times on each side of the plate, avoiding the errors brought by fabrication methods like laser cutting.

### Applications

To demonstrate the functionality of the proposed strategy of using pre-stressed plastic HCMs as skeleton and force amplifiers in robotic propulsion, the kinematics of a self-contained dual-HCM biped robot and a tethered counterpart is studied in this section.

### A. Self-Contained Dual-HCM Biped Robot

The composition of the self-contained biped soft robot is discussed below. It moves forward by snapping against the substrate and generating anisotropic friction through the silicone rubber pads on the feet. Despite the simplicity of the design, the proposed bi-stable HCM soft crawler exhibits a superior high locomotion speed in the described experimental setup. On a flat and clean wood substrate, it can achieve a linear galloping speed of 1.56 BL/s, or 313 mm/s, during the video time length of about 2s. Such a speed is a several- to ten-fold increase compared to other untether soft robots. The video frames of the HCM biped robot show that its locomotion gait is similar to that of high-speed vertebrates like cheetahs and wolves when they are running. Affected by gravity of the robot, the upward bending (contraction in length) and downward bending (extension in length) is unequal. The upward bending of the dual-HCM spine not only needs to overcome the energy barrier of the HCM chassis but also need to vertically lift up the robot, and thus have less kinetic energy built up. The process is usually featured by a very low horizontal speed and a comparatively higher vertical speed. The feet of the robot can be shortly off the ground (˜70) ms), just like the galloping gait of cheetahs. The downward bending of the dual-HCM spine, however, borrows strength from the potential energy, thus has a higher horizontal speed and enables the crawler to cover most of the distance.

The snapping of the two HCMs in the chassis of the robot usually takes 70-200 ms according to our test, giving an angular velocity of 400-3500 deg/s depending on the snapping direction. In comparison, a cheetah can stride up to 4 Hz during its fastest locomotion, where its angular velocity is approximated to be 1000 deg/s based on the literature and online video of a cheetah running. These fast-swinging kinematics enable the HCM spine to exert high force against the ground and locomote the soft robot at a speed comparable to rigid robots and terrestrial animals (1 to 100 BL/s).

Several major factors influence the galloping speed of the robot. For example, the influence of actuation frequency of the single-servo driving system is almost linear, which means the higher the frequency the faster the robot runs. The influence of the substrates, however, may be more complicated. On smooth surfaces like wood, glass, and indoor marble floor, the speed has a positive correlation with the difference in friction coefficient between the two kinds of contacts (plastic and rubber contacts); while on a coarse substrate like concrete, this anisotropic-friction-driving locomotion seems to fail and the speed drop to 0 because of the roughness of the surface. With a more irregular and fluctuating texture of the surface, the plastic contacts between feet and substrate may generate more friction force than the rubber ones, thus neutralizing the anisotropic friction mechanism.

Note that despite the unconventional material used, the motion of the proposed crawler is supported and actively amplified by the continuous deformation of the prestressed HCM actuators under single-servo actuation. The stored energy in the elastically deformed HCMs, which can be tuned by changing the geometric dimensions, plays a dominant role in the force amplification, thus affecting the force output, velocity, and energy efficiency of the robot. It is reported that a more energy-stored bi-stable mechanism generates a larger energy gap, thus offering a larger force exertion and higher speed. However, the HCMs of higher energy barriers increase the energy consumption of the system because they require a higher working voltage and a stronger servo motor to overcome the gap. Therefore, a trade-off should be considered when selecting the prestressing level of the HCM.

### B. Tethered Dual-HCM Biped Robot

To further study the potential of the proposed HCM strategy in soft robotics, we design and fabricate a similar tethered biped robot. After removing the battery and controlling system from the chassis, the robot achieves a total weight of 41 g, which is 57% of its self-contained counterpart. Experiments show that this robot can make use of two completely different gaits to move forward, depending on whether one or two HCMs are triggered during the actuation. This is because the fore-HCM ribbon is angled in the central area of the robot to support the servo, making it a slightly stiffer and harder to buckle than the rear-HCM. By carefully configuring the rotation range of the servo horn, we can locomote the robot in either a sliding-and-jumping pattern with only one HCM buckling or a galloping mode with both the HCMs buckling. We term the motion sliding-and-jumping pattern because the robot will slide forward and take a small leap at the end of each period to recover. The reason why the untethered robot generally does not have this trait is that its larger weight makes it hard to only buckle one side of the chassis.

The speed of these two moving patterns is measured to be 1.28 BIJs and 0.96 BL/s for the sliding-and-jumping mode and the galloping mode, respectively. Interestingly, although the robot is 43% underweight, the tethered robot is slower than the untethered robot. This is because the friction difference is also proportional to the weight and the light weight of the tethered robot leads to more vibration and collision that make the robot harder to maintain a stable motion thus lowering the speed. Therefore, the HCM technique is more suitable for untethered robots. It is also interesting to see that the tethered robotic gait with only one HCM buckling is faster than the normal galloping gait with both the HCMs buckling. The high jump gait indicates that the tethered robot can jump off the ground for 146 ms (58% of the total time) and 34 mm in each actuation during the galloping mode, while the sliding-and-jumping mode keeps the forefeet of the robot in contact with the ground most of the time, reducing vibration and collision and maintaining a more stable movement. With the multi-stable feature of the pre-stressed HCMs, more intriguing gaits can be designed.

### Comparisons

Many previous studies have drawn people's attention to the fast and strong locomotion of soft robots. These soft-bodied crawlers, mostly having continuous compliant bodies and mono-stable structures, demonstrate a relatively slow speed in the range of 0.45 to 40 mm/s or 0.008 to 0.6 BL/s because of either slow actuation speed or weak force exertion of the robots. Using semi-rigid 2D material as the compliant body as well as the force amplifier of the crawler, the proposed HCM soft robot is 5.2 times faster in mm/s than the isoperimetric soft robot and 2.6 times faster in BL/s than the SMA-based soft crawler. Meanwhile, it requires simple 2D fabrication and easy assembly methods due to the benefit of the in-plane prestressing.

### Conclusion

In this work, we propose the method to design rapid soft locomotive robots by prestressing 2D materials like plastic sheets, which we termed hair-clip mechanisms or HCMs due to their inspiration from the hair clips. We derive the design principles using the theoretic solutions obtained from previous work and fabricate a quadri-stable biped HCM crawler with two HCMs connected head-to-head. A recording-breaking speed of 313 mm/s or 1.56 BL/s in untethered terrestrial soft robotics is measured in the experiments, which is 5.2 times faster in mm/s and 2.6 times faster in BL/s than the previously reported fastest one, respectively. The influence brought by multiple factors, including actuation, frequency, substrates, tethering/untethering as well as symmetric/asymmetric actuation is discussed based on various experiments.

### Manuscript 2: Faster Swimming Robots Based on In-Plane Prestressed Instability

### Introduction

Bistable and multi-stable mechanisms are widely found in nature and technology to create rapid and repetitive tasks like hunting, locomoting, and fast deformation. These mechanisms achieve large shape transitions in a short amount of time while being both elastic and reversible. Bi-stability is thus useful for programmable materials, morphing structures, and novel applications spanning several orders of size magnitude. On the other hand, pre-stressing helps increase the elastic energy released and its release rate in each actuation. Examples of prestressing and multi-stability are common. Many plants can build up elastic energy through osmosis and turgor pressure. A sudden release of this energy can cause rapid movements and plays a critical role in their functions like reproduction and nutrition: the ballistic seed dispersal of Impatiens and squirting cucumber after prestressing their seedpods, the pollen dispersal of trigger plants; the rapid leaf closure of the iconic Venus flytrap, etc. However, the build-up of turgor pressure takes large amounts of time and thus cannot support the continuous operation of the prestressed mechanisms.

Interestingly, this prestress-and-snap mechanism is rarely observed in the animal kingdom. Just like animals do not evolve wheels, they cannot grow prestressed and buckling mechanisms due to biological constraints. Prestressing and instability bring about constant static load and repetitive dynamic load, respectively to the motor systems of animals, and thus can lead to fatal damages. The closest examples, though, would be bird feet that use energy-storing tendons to play zero-powered perching and hummingbird beaks that close fast through snapping due to their being bistable structures. Therefore, combining prestressed structures with bistable mechanisms for biomimetic locomotion can be a potential method to not only mimic animals but also see how far the idea can be extended using non-biological materials.

Compared to traditional robotic mechanisms made of rigid links and joints, soft mechanisms are safe, versatile, more bio-mimic, and bio-compatible because of the elastic and compliant materials used, but are intrinsically weaker in force exertion and fast-moving. The moduli of soft materials are usually in the order of 104-109 Pa. In many cases of soft robots, large blocks of elastomer for self-supporting and end-effectors leads to a comparatively low energy density; the widely used fluidic actuation also dissipate too much energy in viscous friction with the tube, especially when the actuation frequency is high. To address these problems, about three potential solutions are proposed: larger energy input, higher frequency, and using structural instability. For example. Shepherd et al., Bartlett et al., Tolley et al.

Keithly et al. used explosive actuators to power jumping robots. These robots usually move fast but in a very uncontrollable and unrepeatable pattern and are difficult to repeat frequently. In addition, the soft materials accommodating the explosive impact degenerate rapidly after a few repetitions. Mosadegh et al., Huang et al., Li et al., and Wu et al, designed soft robots with high actuation speed or frequency. However, the highest achievable speed or frequency is severely limited by the low moduli and elastic wave velocities of elastomers, which hinders the use of this method. Tang et al, built a galloping soft robot with a high speed of 2.68 body length per second (BL/s) and a soft swimmer of 0.78 BL/s by utilizing structural instability. Other researches also point to the potential of multi-stable structures leading the next-generation soft robotics. However, presently reported multi-stable structures are still complex in constitution, assembly, and fabrication processes, impeding their development. The method illustrated in this work proposes to create strong bi-stable mechanisms using prestressed 2D materials, which largely decrease the difficulty in design and fabrication.

### Using Bi-Stability for Repetitive Propulsion

Enlightened by buckling and post-buckling knowledge and the fact that most fast-moving animals in nature need a hard skeleton, we demonstrate the geometry and assembly of a hair-clip-like in-plane prestressed mechanism that is fabricated with materials like metal, plastic, and paper. Even though these materials are high in modulus, the out-of-plane stiffness of the slender ribbons made from them is usually smaller than the membrane stiffness by an order of 10⁵˜10⁶, making the ribbons compliant and deformable. By pinning the two extremities of the angled ribbon together with an eyelet rivet, the lateral-torsional buckling of the angled ribbon creates a bi-stable thin-wall spatial surface with non-zero Gaussian curvatures, i.e., a thin-wall dome. The out-of-plane bending angle ψₗ of the ribbon tip (z=l=L₁+L₂) can be calculated from

$${{ψ}_{l} \approx \frac{du}{dz} \vert}_{z = l} = - \frac{{P}_{cr}}{{EI}_{η}} {\int }_{0}^{l} φ ( l - z ) dz , \qquad ( 1 )$$

with Pcr being the critical load of the lateral-torsional buckling of the angled ribbon, EIₙ being the bending stiffness along the η axis, and φ being the angular displacement of the section. Detailed assumptions and derivation can be referred to in the Supplementary Information (SI). The above equation tells the swing amplitude of the HCM during a snap-through. Interestingly, Eq. (1) indicates that ψₗ, a key factor for the kinematic performance of the hair clip mechanism (HCM), is independent of the material modulus E and dimensions like L₁, L₂, h, and t, but is only affected by the unitless shape factors θ and γₛ=L₂/L₁, meaning this mechanism is scalable. The estimation of Eq. (1) gives an error smaller than 5% compared to the experimental measurements by a bending sensor.

Another key aspect of the HCM is its dynamic feature, which is given by the time scale of the snap-through

$$t , \overline{t \sqrt{\begin{matrix}El & Ps\end{matrix}}} \qquad ( 2 )$$

where ρs is the density of the material. A plastic HCM with ρs=1.2 g/cm³, thickness t=0.381 mm, E=1.73 GPa (SI), and l=175 mm takes about 40 ms to snap and the angular speed is ˜ 4×10³°/s, while a steel HCM with ρs=7.85 g/cm³, 1=0.254 mm, E about 200 GPa, and l=175 mm only takes about 16 ms and have an angular speed of ˜ 14×10³°/s. The theory gives a good estimation. These velocities are comparable to those of the throws of a professional baseball player of ˜ 9000°/s and much faster than the tail beats of fish which is about 100˜ 1000°/s. In the quasi-static energy-storing stage, the tip bending angle |ψₗ| of an HCM further increases, and when it snaps, the total energy was released in several to tens of milliseconds, generating fast reverse swinging and small shock waves that result in a clear snap sound. Excessive energy is then dissipated through oscillation.

We also noted that the global snap-through of the HCM can be triggered by the inversion of the central segment (denoted by L₁). This means HCMs can be triggered conveniently by assorted actuation that offers a point displacement at one end, allowing the protruded long props (denoted by L₂) to be used as end effectors of robots or manipulators. This local-global actuation is termed “bend-propagating actuation” in the relevant literature. With characteristics like bi-stability, easy actuation and fabrication, and scalability we believe the in-plane prestressed HCM can be used in domains like origami/kirigami structures, deployable devices, morphing airfoils, etc.

### Untethered Motor-Drive HCM Fish Robot

Inspired by the resemblance of the HCM snapping and the undulation of the compliant bodies of fish, we used an HCM in an untethered fish robot to demonstrate its function in aquatic propulsion. The dimensions and weight of the untethered fish robot are length×width×height=21.5 cm×4.5 cm×12.0 cm and 125 g, respectively. It is made of two major parts: an HCM (coral colored, film thickness t₁=0.762 mm) with a riveted thinner plastic sheet (blue, film thickness t₂=0.127 mm) as compliant fish body and fish tail, respectively, and a hollow 3D-printed fish head to guide and balance the motion and to accommodate the Li-ion battery cells, a BLE microcontroller, a servo motor, and wiring stuff to make the robot self-contained. The HCM used in the fish has a shape of γₛ=2 and θ=−23.5°, which yields a tip undulation amplitude of 2·ψₗ=68° according to the theory. The horn of the onboard mini-servo passes through the narrow opening of the waterproof layer made of silicone rubber and moves the center of the HCM ribbon left and right alternately so that the bi-stable HCM can buckle to the opposite sides accordingly. It takes the HCM fish 17 ms and 50 ms to snap in air and underwater, respectively, due to the different drag of the media. The effect of this nonlinear tail beating is discussed in the next section. This repetitive snap-through buckling enables the robot to undulate like a real fish. The blue plastic sheet at the rear of the robot functions as a caudal fin and increases aquatic propulsion.

The equivalent density of the fish robot is set to be slightly smaller than that of water by tuning the weight of the ballast made of silicone rubber and steel balls so that it can float and receive Bluetooth signals. Besides, the high-density ballast help lower the center of gravity and stabilize the orientation of the fish during its swimming. Curvilinear movement is created by adding minor asymmetry to the riveting scheme between the HCM and the caudal fin and is used to provide a longer image sequence for the calculation of swimming speed. Measurements are conducted by comparing the displacement covered in Is intervals to the length of the fish in the image and it takes the robot about 12.7s to cover the circular path of 554 cm. With the servo powered by a 7.4V battery pack and a tail beating of 3 Hz, the fish robot can move at an average speed of about 2.03 BL/s (or 43.6 cm/s), which is comparable to the 2˜10 BL/s swimming speed of biological fishes. This is the fastest untethered soft robotic swimmer, to the best of the authors' knowledge, outperforming the previously reported highest speeds of 0.69 BL/s and 23.5 cm/s by 194% and 86%, respectively. Compared to other predecessors, the HCM fish not only excels in velocity per actuation frequency but also triumphs in the simplicity of assembly and fabrication. Interestingly, our fish doesn't scare away aquatic lives but arouses their curiosity sometimes, which indicates its potential for non-disruptive environmental exploring.

The straight swimming of the robot in the aquarium shows its starting stage and an average acceleration of 20.1 cm/s² is observed. As expected, the propulsion force increases monotonously w.r.t. flapping frequency of the fish. The nonlinearity of both the speed and force plots is due to the nonlinear relation between drag and speed that F_{D} ∝v². These results also indicate that the speed can be further increased.

### Tethered Pneumatic HCM Fish Robot

To further examine the performance of the HCM and its compatibility with soft actuation methods, a pneumatic fish robot is designed and tested in this section. Using an external energy source and control system, the robot can be made smaller and lighter with dimensions of length×width×height=18.6 cm×6.5 cm×5.2 cm and a weight of 42 5 g. It consists of a pneumatic-driven HCM (pink, film thickness t₁=0.381 mm) as a fish body, a riveted thinner plastic sheet (grey, film thickness t₂=0.191 mm) as a fishtail and a hollow 3D-printed fish head with ballast to guide and balance the motion. The HCM used in the fish has a shape of θ=−3° and γₛ=6, which yield a tip bending angle ψₗ=39°. A pneumatic HCM is built by attaching a pair of antagonistic soft pneumatic bending units on both sides of the HCM. When gas is pumped into these pneumatic networks (pneu-nets), their bending deformation will snap the mechanism. An alternate actuation of the pneu-nets would enable the HCM to undulate like a biological fish.

With an actuating pressure of 150 kPa and a frequency of 1.3 Hz (period=760 ms), the HCM-based bistable pneumatic soft robotic fish swims underwater at an averaged horizontal speed of 1.40 BUs or 26.54 cm/s (calculated from trigonometry) which is twice as fast as the monostable reference swimmer with the same weight (41.6 g) and same actuation conditions. The reference fish robot, instead of using bistable HCM for the fish body, features a flat and mono-stable plastic sheet with attached pneumatic bending units as actuators. A near-linear actuation swinging is observed in the reference swimmer, while the HCM-driven one shows nonlinear swinging and gains more kinetic energy from each flapping. This is because the drag of fluids is proportional to the squared value of the flapping speed. Even though the HCM fish robot swings with a slightly smaller amplitude than the reference, its angular speed in water is 1200°/s when its body snaps, about three times that of the reference model of 340°/s in its linear swings.

A significant feature of the untethered fish robot is its resemblance with the real fish, while the pneumatic and reference models both have obvious deviation. This shows that the bio-fish undulation can be repeated by the HCM method. Despite having a smaller speed than the untethered counterpart, the pneumatic HCM fish has the largest single strike distance among all robots and is almost as good as the real fish, i.e., it has the highest speed per actuation frequency not only among the three robots but also among all previous soft swimmers. Measuring from the sequences, their Strouhal numbers are Stᵤₙₜₑₜₕₑᵣ=3×0.041/0.436=0.28, Stₜₑₜₕₑᵣ=1.3×0.045/0.265=0.22, and St_{ref}=1.3×0.065/0.131=0.65, indicating the HCM fish have high propulsive efficiencies.

Contrary to the convention that untethering a soft robotic swimmer usually decreases its swimming capacity, having the energy source and control system onboard for an HCM robot increases its speed. This is because the additional weight of the battery and controlling system has little influence on our design since we need weights and ballast to sink the fish anyway, yet the mechanical actuation of a servo is more powerful than soft actuation.

Following the experiments and the energy analysis in the SI, the speed of the HCM-driven fish robots can be increased either by using a larger actuation frequency or by elevating the energy barrier of the HCM to raise the energy released in each snapping (increasing shape factors θ or decreasing γₛ, shown in Eq. (S17)), which may require higher energy input. For example, a pneumatic HCM with shape factors θ=10° and γₛ=6 is undulating with an amplitude of ±50° and a frequency of 2.5 Hz, and the actuation pressure required becomes 300 kPa, which is two times the pressure in the 1.3 Hz undulation. This also means that energy efficiency is impaired due to larger energy loss in the pneumatic system.

### Conclusion

Harnessing the prestressing and bi-stability of 2D materials opens a new way to morphing mechanisms with enhanced capability and functionality, inspiring applications in diverse fields and scales. Our research not only provides principles for designing and fabricating such hair-clip-inspired mechanisms but also demonstrates the advantages of HCMs as the propulsion method for fish robots. The high force and high speed of the HCM propeller give a record-breaking speed for the untethered compliant swimmer with a significant improvement of 194% compared to conventional ones. The pneumatic HCM fish, on the other hand, indicate the compatibility of HCMs with multiple actuation methods. With an eleven-fold increase in structural rigidity high motion capacity, and energy-storing properties, the HCM combines the functions of skeletons to bear load and muscles to amplify force. This method can be a breach to compete with lives with soft robots and can play a part in the revolution of fast and strong soft robotics.

### Derivation of the Theory

The assembly and function of the hair-clip mechanism (HCM) are described above. Displacement components u, v, and φ are measured on centroid C of an arbitrary section mn along x, y, and z axes (undeformed coordinates), respectively, with signs following the directions of axes and right-hand rule; the ξ, η, and ζ axes (deformed coordinates) are drawn through the deformed centroid C′ of the section mn, coinciding with the principal axes of the deformed configuration. Following the small deflection theory and Euler's beam theory, and assuming the angled ribbon to be a straight cantilever beam of a rectangular section, the mathematical model of the assembly process can be given by the following equations:

$${EI}_{ξ} \frac{{d}^{2} v}{{dz}^{2}} + P ( l - z ) = 0 \qquad ( S1 )$$

$${EI}_{η} \frac{{d}^{2} u}{{dz}^{2}} + P φ ( l - z ) = 0 \qquad ( S2 )$$

$$C \frac{d φ}{dz} + P ( l - z ) \frac{du}{dz} - P ( {u}_{1} - u ) = 0 \qquad ( S3 )$$

in which Eli is the bending stiffness of the axis, l=L₁+L₂ is the half-length of the strip, C=GJ=hb³G/3 is the torsional rigidity of the thin rectangular section mn, u₁ is the horizontal deflection at z=l, and G is the shear modulus. Differentiating Eq. (S3) w.r.t z and plugging in Eq. (S2) yield

$$C \frac{{d}^{2} φ}{{dz}^{2}} + \frac{{{P}^{2} ( l - z )}^{2}}{{EI}_{η}} φ = 0 \qquad ( S4 )$$

The general solution of Eq. (S4) can be analytically given as

$$φ = \sqrt{s} [ {A}_{1} {J}_{1 / 4} ( \frac{{β}_{1}}{2} {s}^{2} ) + {A}_{2} {J}_{- 1 / 4} ( \frac{{β}_{1}}{2} {s}^{2} ) ] \qquad ( S5 )$$

where s=l−z, J_{1/4} and J_{1/4} represent Bessel functions of the first kind of order ¼ and −¼, respectively, and the notation

$${β}_{1} = \sqrt{\frac{{P}^{2}}{{EI}_{η} C}} . \qquad ( S6 )$$

Due to the symmetry of the ribbon and small deflection assumption, integration constant A₂=0 can be inferred from the boundary condition

$${φ \vert}_{s = 0} = 0. \qquad ( S7 )$$

Thus, the general solution of Eq. (S1)-(S3) can be described by

$$φ = \sqrt{s} {A}_{1} {J}_{1 / 4} ( \frac{{β}_{1}}{2} φ = \sqrt{s} {A}_{1} {J}_{1 / 4} ( \frac{{β}_{1}}{2} {s}^{2} ) \qquad ( S8 )$$

with A₁ being a non-zero integration constant. This means the ribbon will buckle approximately in the shape of a Bessel function. Similarly, another boundary condition of the beam is

$${φ \vert}_{s = l} = 0 \qquad ( S9 )$$

Due to the lack of lateral support on the beams, the lowest root of the Bessel function should be used when combining Eq. (S8) and (S9), which yields

$$\frac{{β}_{1}}{2} {l}^{2} = 2.7809 \qquad ( S10 )$$

Plugging in Eq. (S3), the critical load of the lateral-torsional buckling is

$${P}_{cr} = \frac{5.5618}{{l}^{2}} \cdot \sqrt{{EI}_{η} C} \qquad ( S11 )$$

To determine the value of A₁ and then φ, an additional equation, usually the energy conservation equation, is included. The energy equation dictates that the total elastic strain energy of the structure must equal the work done by the external load. Ignoring the membrane strain energy, we have

$$\begin{matrix}U = \frac{1}{2} {\int }_{0}^{l} [ \frac{{M}_{η}^{2}}{{EI}_{η}} + {GJ ( \frac{d φ}{dz} )}^{2} ] dz \\ = \frac{1}{2} {\int }_{0}^{l} [ {{P}_{cr}^{2} ( l - z )}^{2} {sin}^{2} φ / {EI}_{η} + {GJ ( \frac{d φ}{dz} )}^{2} ] dz\end{matrix} \qquad ( S12 )$$

$$T = {P}_{cr} \cdot {L}_{2} ( {sin}^{- 1} \frac{1}{{γ}_{s}} + θ ) \qquad ( S13 )$$

$$and$$

$$U = T \qquad ( S14 )$$

in which U is the elastic strain energy, M_{η} is the moment on the beam along axis η, and T is the external work done by P_{cr}. The typical value of A, is 0.09-0.10, depending on the value of γₛ=L₂/L₁, and θ. The analytical expression of φ is then calculated from Eq. (S8). Finally, by plugging Eq. (S8) into Eq. (S2), the out-of-plane bending angle ψ of the section mn can be calculated from

$$ψ \approx \frac{du}{dz} = - \frac{{P}_{cr}}{{EI}_{η}} {\int }_{0}^{z} φ ( l - z ) dz \qquad ( S16 )$$

The derivation of the energy profile needs additional assumptions because the energy-storing process is path-dependent. Assuming the snapping of an HCM is similar to that of an axially compressed beam, the dimensionless energy barrier of the bi-states of the HCM can also be derived from the above inference (SI), which is

$${\overline{U}}_{barr} \approx 3 \overline{U} \vert \text{?} = 3 {P}_{cr} \cdot {L}_{2} ( {sin}^{- 1} \frac{1}{{γ}_{s}} + θ ) \qquad ( S17 )$$

$$\text{?} \text{indicates text missing or illegible when filed}$$

To calculate the energy barrier of the bi-stable HCM, we assume the assembled HCM is perfectly symmetric and the local maximum and minima of the tip bending angle are

$${{ψ}_{i} \vert}_{\frac{dU}{d {ψ}_{i}} = 0} = - {ψ}_{eq} , 0 , {ψ}_{rq} , \qquad ( S18 )$$

where ψ_{eq} is the equilibrium tip angle after assembly, and thus energy barrier

$${U}_{barr} = U \vert \text{?} - U \vert \text{?} \qquad ( S19 )$$

$$\text{?} \text{indicates text missing or illegible when filed}$$

### Verification of Theory

According to the theory, the HCM ribbons buckle in the shape of a Bessel function when it is assembled, as in Eq. (S8). We reproduced this process in the finite element (FE) software of ABAQUS/Standard for an HCM with shape factor θ=10°, γₛ=6, and other parameters h/L₁, =15 mm 12.5 mm and t/L₁=0.381 mm/12.5 mm. The simulation uses 756 shell elements S4R and the material is assumed to be linear elastic with a Young's modulus (E) of 2 GPa and Poisson ratio (v) of 0.3. And the theoretic solution of the rotation angle φ is calculated using Matlab.

The accuracy of Eq. (S16) is also discussed in the main text. Counterintuitively, tip bending angle ψₗ decreases with an increasing dimensionless prop length γₛ. The verification of the energy barrier is through finding the difference between the maximum and minimum of the strain energy profile when HCM snaps in the FE simulation. Again, the energy gap U_{barr} also depends merely on the parameters θ and γₛ, indicating the scale-free nature of HCM. For example, increasing the thickness t by twofold doesn't change ψₗ and U_{barr} yet leads to an eight-fold rise in U_{barr}. These scalable features can inspire novel designs of morphing structures, metamaterial, and soft robots in both macro- and milli-scales.

### Fabrication of the Fish Robots

Both the fish heads from the motor-driven fish and the pneumatic fish are modeled in Solidworks and 3D printed. The plastic HCM ribbons are laser-cut (using Thunder Laser Nova 51) from color-coded shims (McMaster-Carr, 9536K) and metal HCM ribbons are water jetted from stainless steel shim stock sets (McMaster-Carr, 93005K). In the assembly of these HCMs, the extremities of HCMs are pin-locked using press-fit rivets (McMaster-Carr, 97362A). The pneumatic soft bending units are fabricated using the 3D-printed molds (Ultimaker S3. PLA) and cast with Dragon Skin 20 (Smooth-On Inc.). Plastic glue (Loctite Super Glue) is used to bond the cured silicone rubber bending units to the plastic shims.

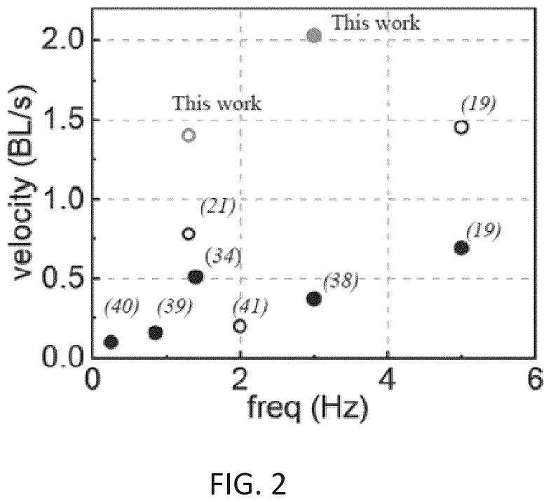

A broader comparison of robotic speed and frequency of our research to other works is shown in FIG. 2. The hollow circles in the figure denote tethered swimmers and solid circles denote untethered ones.

### Material Properties

The Young's moduli of the materials of an HCM have a critical influence on its mechanical features. While the modulus of the steel can be estimated to be 200 GPa, the moduli of the PETG color-coded plastic sheet (McMaster-Carr, 9536K) and the silicone rubber (Smooth-On Inc., Dragon Skin 10) are measured via a tensile machine (SUNS. UTM4000), following the guidance of ASTM D882 and ASTM E8/E8M, respectively. Five PETG samples are laser-cut (Thunder Laser Nova51) and three silicone rubber samples are cast from 3D-printed molds (Ultimaker S3. PLA plastic). Assuming linear elasticity, the moduli of the PETG plastic sheets (averaged from 5 samples) and Dragon Skin 20 silicone rubber (averaged from 3 samples) are 1.73 Gpa and 885 kPa, respectively.

### Pneumatic Actuation of the HCM

By gluing pneumatic bending units to the surface of an HCM, we create a bi-stable fishtail mechanism whose snap-through buckling can be triggered by pumping air into the bending pneu-nets. The pressure needed for the onset of HCM snapping, which is called critical pressure, can be measured. A quasi-static pressurizing scheme is applied until snap-through, and the critical pressure is measured on HCMs with different values of shape factor θ yet constant γₛ=6. The curve is divided into two linear segments. The linear relation is because the energy barrier of the HCM is proportional to shape factor θ, according to the theoretical expression of the energy barrier in Eq. (6). The slope of the curve is smaller when θ>0 than when θ<0. This is because the ridges of the soft pneu-nets will contact and interfere with each other at the rest state when θ>0 and make the snap-through of the pneumatic HCM easier.

Manuscript 3: Rapid Grasping of Fabric Using Bionic Soft Grippers with Elastic Instability

### Introduction

Human hands have approximately 27 degrees of freedom (DOF) and a large number of muscles, which enables them to manipulate all kinds of objects with strength, dexterity, and delicacy. Most robots grasp through a complex system of motors which makes the resulting designs inevitably rigid and bulky. Soft robotic grippers, also known as compliant or adaptive grippers, on the other hand, are a new type of robotic end-effector mimicking hands and animal tentacles for handling delicate or fragile objects. Due to the flexible materials used, these grippers can conform to the shape of the object being grasped and apply gentle forces without causing damage. The advantage of being bio-compatible, human-friendly, and highly adaptive gives them an important role in next-generation robotics. Becker et al. use entanglement grasping to circumvent challenges of object recognition, grasp planning, and feedback, via filament-like soft actuators. Yang et al, present a soft gripper using a simple material system based on kirigami shells. Brown et al, design a universal robotic gripper based on the reversible jamming effect of granular material. However, the moduli of the materials used for these grippers usually range from 10-1000 kPa, which is smaller than a hundred thousandth the modulus of steel used for rigid robots. This intrinsic softness of materials makes their grasp weak in force and slow in motion, which is also far from the strength and dexterity of human hands.

Bi-stable grippers are systems that store elastic energy and release it in a short amount of time, achieving mechanic performance such as larger force and high speed. Besides, bi-stability also helps these systems to save energy since no energy supply is needed to maintain their grasping. Due to these features, bi-stable grippers are thriving in recent years. Zhang et al, design a soft gripper with carbon-fiber-reinforced polymer laminates that snaps within 112 ms. Thuruthel et al, build a soft robotic gripper with tunable bistable properties for sensor-less dynamic grasping which capture objects within 0.02 s. Wang et al. present a soft gripper based on a bi-stable dielectric elastomer actuator (DEA) that only takes 0.17 s and 0.1386 J to snap. Zhang et al, present a 3D-printed bistable gripper that allows a palm-size quadcopter to perch on cylindrical objects. McWilliams et al, develop a push-on and push-off bistable gripper that reduces the complexity of grasping. Estrada et al, and Hawkes et al, present a bistable gripper with gecko-inspired adhesives to grasp spinning objects. Lerner et al, propose a bistable gripper with variable stiffness. However, most of these bistable grippers have complex fabrication procedures and limited adaptivity. For example, none of them can emulate the ability of human hands to pick up a piece of fabric. To address these challenges, we propose to use the prestressed bi-stable hair-clip mechanisms (HCM) as end effectors for robotic manipulation.

Compared with other bi-stable grippers, the simple structure, easy fabrication, and convenient assembly make the HCM soft gripper cheaper, lighter, and faster. The in-plane prestressed HCM fingers work as force amplifiers as well as load-bearing skeletons, enabling them to manipulate both large and small, thick and thin, and rigid and limp objects with speed and strength. Since the HCM fingers mimic the kinematics of the thumb-index finger pinching, the gripper can not only pick up tangible objects like pens and beakers but also can manipulate thin and soft objects like fabrics. The semi-rigid plastic sheets used for the HCMs function as nails to exert force when dealing with limp objects, and additional silicone rubber coatings can work as finger pulps to elevate friction coefficient.

It is estimated that 80% of the total production line time in the garment industry is spent on the handling and manipulation of fabrics. To automate the apparel manufacturing industry, a human-safe gripper that is capable of rapidly manipulating fabrics without damaging them is very attractive. Existent studies demonstrate a series of soft robotic methods that are specified for fabrics. Such methods include pins/needles, vacuum suction, air-jet, gluing, electrostatic, etc. For better efficiency, they sacrifice certain levels of adaptivity and compatibility. To address that and to offer new methodologies, we show in this work that a universal soft gripper with the capability of fabric manipulation is approachable.

### Theory of Hair-Clip Mechanism (HCM)

It is proved in om previous work that an HCM can be efficiently used as a skeleton and force amplifier for compliant fish robots and tenestlial crawlers and beat previous records with a three-fold and a five-fold improvement, respectively. The bi-stability of HCM plastic ribbons can increase the angular velocity of a robotic fishtail by about 3 times during snapping and the dome-like structure of the ribbons from their buckled configuration can increase their bending rigidity by about 11 times. All of these features contribute to the performance of om HCM gripper in this paper. Due to the same theory used, the shape and properties of HCM grippers can be derived similarly. Thus, the timescale of the snapping process of the HCM fingers can be estimated as

$${t}_{*} = \frac{{( 2 l )}^{2}}{t \sqrt{E / {ρ}_{s}}} , \qquad ( 1 )$$

where l is the effective length of the half ribbon. E is the material modulus, t is the thickness of the material, and ρₛ is the density of the material. The opening gap W between the two fingers has a dimension of

$$W = {L}_{f} + 2 \cdot u ( l ) = {L}_{f} - 2 \cdot \frac{{P}_{cr}}{{EI}_{η}} {\int }_{0}^{l} {\int }_{0}^{z} φ ( z ) ( l - z ) dz dz , \qquad ( 2 )$$

in which L_{f}=48.0 mm is the installation gap between the fingers, u(l) is the lateral deflection u(z) at z=l, and the critical load P_{cr} of the ribbon's lateral-torsional buckling and the lateral rotational angle φ are, respectively.

$${P}_{cr} = \frac{5.5618}{{l}^{2}} \cdot \sqrt{{EI}_{η} C} , \qquad ( 3 )$$

$$φ ( z ) = \sqrt{l - z} {A}_{1} {J}_{1 / 4} ( \frac{1}{2} \sqrt{\frac{{P}_{cr}^{2}}{{EI}_{η} C}} {( l - z )}^{2} ) , \qquad ( 4 )$$

C=Ght³/3 is the torsional rigidity of the ribbon, A₁ is a non-zero integration constant derived from energy conservation, J_{1/4} is the Bessel equation of order ¼, and I_{η}=h³t/12 is the area moment of inertia of the ribbon. The energy released in each grasp of the gripper equals the energy gap between the bi-states of the fingers which is

$${U}_{barr} = 6 {P}_{cr} \cdot D . \qquad ( 5 )$$

This energy will dissipate in friction and collision, resulting in high force and high speed.

### Grasping Limp Objects

We propose to use the bi-stable HCMs to mimic the fabric grasping motion of human fingers. To the best of the author's knowledge, this is the first soft gripper that can deal with both stiff and limp objects. The challenge of manipulating limp objects is due to the disparate criteria between grasping 2D objects and 3D objects. Before the “liftable” condition that friction 2 F·μₗₛ>object gravity G, picking up limp objects has two more preconditions: the friction force of the grasping should be larger than the friction force at the bottom of the fabric; the grasping force should be larger than the bottom friction plus the Euler's critical load of the fabric. We term the two preconditions as “manipulable” and “wrinklable” prerequisites. Based on this theory, the properties of our bi-stable soft grippers are very suitable for this task. The HCM fingers have a large opening gap W that is usually several times the actuation distance, offering enough space to wrinkle and grasp the cusp of the fabric. And the snap-through buckling can generate a large instant force Fₘₐₓ that is unusual in soft grippers, helping overcome friction and resistance. Moreover, bi-stability offers grasping force F without energy input, which is beneficial in long-term manipulation.

### Fabrication and Measurements

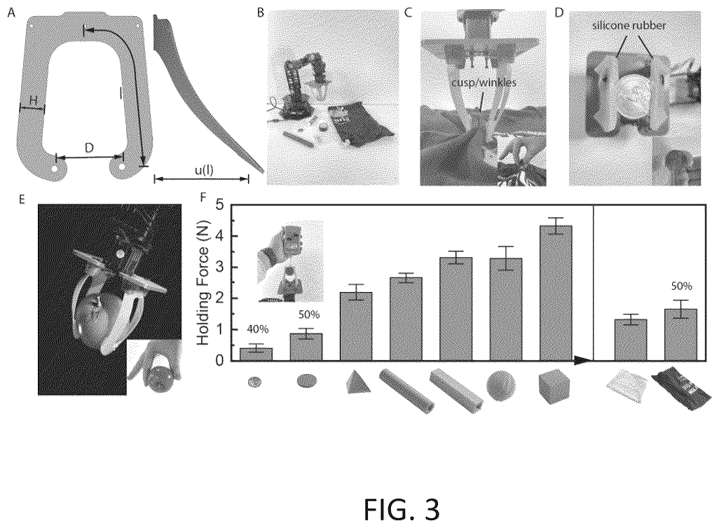

The HCM gripper is composed of two plastic HCM fingers (McMaster-Carr, 9536K), a 3D-printed clamping panel (Ultimaker S3, PLA), and a robotic arm (Trossen Robotics, WidowX). An energy source of 12 V is needed for the operation of the actuators and microcontroller (Dynamixel, MX-64, MX-28, AX-12A, ArbotiX Robocontroller). Although multiple materials from paper to steel sheets can be used for HCM designs, we choose semi-rigid plastic material with a modulus of E=1730 MPa to ensure safe interaction and easy fabrication. The HCM fingers are laser cut (Thunder Laser, Nova 51) PETG ribbon with a width of h=15 mm, a thickness of t=0.762 mm, and an effective half-length of l=93.7 mm. To achieve the prestressed configurations, they are pin-locked with press-fit rivets (McMaster-Carr, 97362A), and are coated with silicone rubber sheets (Smooth-On Inc., Ecoflex 10) to increase the friction coefficient μₗₛ. The dome-like configuration (FIG. 3A) of the HCM fingers offers the rigidity and force needed to grasp the objects. Thus, no additional energy is needed for maintaining the closing mode of the gripper.

### Holding Force

Due to the silicone rubber coating and the compliant and curved shape of the HCM fingers, two mechanisms contribute to the holding force: friction and geometric interlocking. For a prestressing level of D=40 mm, the gripper has grasping forces that are fairly large for most rigid objects (up to 4.5 N), considering that the gripper has only two fingers. Though, the coin and the coin-like disc present challenges to the gripper with their small dimensions in the vertical direction. Only 30% and 40% success rates are observed in picking them up based on ten trails, respectively, and low average holding forces of 0.41 N and 0.87 N are obtained. The force of picking up a t-shirt (1.65 N) is larger than that of a single layer of fabric (1.32 N). And due to its self-weight, t-shirt only can be picked up by the gripper in 50% of the cases. Despite that, the HCM gripper has a success rate of 100% in picking up objects like columns, cubes, pyramids, and spheres.

The holding forces range from 0.5-1.3 N, dependent on the thickness and text.me of the matelial, and measured from the total lifting force minus the self-weight. In general, the holding forces for 2D objects are smaller than holding geometric shapes like spheres and cubes. This is because only a small cusp or wrinkled part of the fabric is being held and limp materials can easily slip off. For holding heavier fabric sheets, multiple fingers or HCM arrays can be used.

### Span and Speed

For pinching grippers, the span is important because it determines how large objects the gripper can manipulate. And in the case of fabric grasping, a larger span makes the grasping of limp objects easier since it quadratically decreases the force Fₘₐₓ needed to buckle the sheets and also enables the gripper to take hold of a larger cusp or more wrinkles to have a finer grasp. On the other hand, the speed of grasping is also important for the efficiency of the garment industry since a large portion of the time is spent on manipulating raw materials. However, span and speed usually contradict each other for traditional grippers since it generally takes longer to cover a larger distance. Here we demonstrate that by leveraging bi-stability, our soft gripper can take a grip rapidly, regardless of the large span.

The simulated results of grip span W vs, the prestressing level D are discussed, together with the theoretical and experimental outcomes. The finite-element (FE) analyses of the configuration of the in-plane prestressed HCM are created using ABAQUS/CAE and solved with ABAQUS/Standard. All simulations use about 4600 shell element S4R or S3R and the material is assumed to be linear elastic with Young's modulus (E) of 1730 MPa and a Poisson ratio (v) of 0.38.

Based on the comparison, the simulative results are quite close to the measurements, giving an error of about 5%. And the theoretical solutions calculated from Eq. (2) are within a 10% error compared to the measurements. The span of our HCM gripper is several times larger than that of the original robotic gripper, which is only 32 mm. In some experiments, an inward tilting angle is applied when installing the HCM fingers to increase the holding force, which can decrease the gripper span. For example, an HCM gripper with a span of w=86 mm and a tilting angle of 10° can snap during a short amount of time of 45.8±6.7 ms, close to the theoretical solutions of 53 ms calculated from Eq. (1), while the closing of the traditional gripper with a span of w=32 mm usually takes 0.5 s. The HCM is 10.9 times faster than the reference gripper and can vastly increase the grasping efficiency in the garment industry. Further, a 2 Hz open-close cycling of the HCM gripper and the major limitation can further increase the cycling frequency of the gripper is the rotational speed of the motor (59 rev/min. DYNAMIXEL, AX-12A). The trajectory of the HCM fingers is a curved one, in which the HCM fingers first slightly open during the elastic energy storing stage and then suddenly close, similar to the motion of human fingers in a thumb-index finger pinching, while the reference gripper moves straightly with a uniform velocity.

### Fatigue

For compliant mechanisms that incorporate prestressing and bi-stability, the fatigue problem of the material is essential, since their motion comes from the bending deformation of flexible parts which leads to stress at those locations. The HCM fingers now use PETG plastic which is not specified for repetitive-loading applications. Some more fatigue-resistant materials like carbon fiber composites can be used for future studies. We discuss the fatigue lives of HCM fingers with prestressing D=20 mm made of PETG plastic sheets of thickness t=0.015-0.06 inch. It is found that the PETG plastic sheets can withstand 20000˜ 460 times cycles depending on the thickness, and that tiny cracks appear mostly at the corner of the HCM fingers.

### Application

To demonstrate the functionality of the proposed strategy of using pre-stressed plastic HCMs as end-effectors in robotic manipulation, the performance of the motor-driven HCM gripper with a commercial robotic arm and a pneumatic variant of the HCM gripper is presented in this section.

### Manipulation of Fabric

To challenge the gripper's capacity of fabric manipulation and to increase the efficiency of an actual garment production process, we design this test to exhibit the gripper's ability to pick up a single sheet of fabric from a stack of 50 sheets. The picking-up experiment was carried out with 20×20 cm² cotton squares with a weight of 50 g (0.5 N). In the demonstration, the gripper moves down to the stack, picks up and removes the top fabric, and places it to the side. Success is defined when the gripper holds only the top single sheet in the stack and failure otherwise. The gripper takes 20 seconds to repetitively pick up the top single fabric sheet 10 times, and a success rate of 90% is observed.

### Pneumatic Gripper

To further demonstrate the compatibility of HCM end-effectors, we built a pneumatic version of it. Similar to the motor-driven version, this pneumatic HCM gripper has a minimalistic design that includes two pneumatic-actuated fingers and a 3D-printed panel holding the fingers in position. The pneumatic soft bending units are fabricated with 3D-printed molds and a silicone rubber casting process (Smooth-On Inc., Dragon Skin 20). Upon an actuation pressure of ˜150 kPa. It does thumb-index finger pinching and picks up a piece of initially—flat soft fabric just like the motor-driven one does. Besides, the pneumatic HCM gripper weighs 15 g and can pick up objects of 44 g, which is three times its self-weight. Similarly, the pneumatic variant also only consumes energy when a mode transition is needed, due to its bistable nature.

### Comparisons

To explain the role that the HCM gripper plays in the field of soft grippers, a comparison among the proposed HCM soft gripper and a few representative soft grippers is given in Table I. It summarizes the grippers' ability to pick up objects with various shapes (universal), to grip rapidly, to manipulate fabric, to have a large span, and to harness bistability. It also mentions whether the gripper uses piercing needles if it can deal with fabrics. Compared to others, the HCM gripper possesses an overall advantage in these mechanical properties, due to its bistable structure and its similarity with human fingers in shape and function. Besides, the HCM fingers are easier to fabricate and assemble than most other grippers. It is also noted that, compared to the commercial reference gripper that shares the same controlling system and the same hardware platform, the HCM modification enables the system to work as a bistable soft gripper with the ability to pick up fabric and significant increases in span and grasping speed.

TABLE 1
Comparison among the HCM gripper, reference commercial
gripper, and other soft gripper studies

| | | Fast | | Fabric | Non- | Large | Bi- |
|---|---|---|---|---|---|---|---|
| | Universal | Grasping | | Picking | Piercing | Span | Stable |
| This Work | Y | 46 | ms | Y | Y | 86 mm | Y |
| Ref. | Y | 0.5 | s | N | — | 32 mm | N |
| [4] | N | N | | N | — | N | N |
| [5] | Y | N | | N | — | Y | N |
| [6] | Y | N | | N | — | Y | N |
| [8] | N | 112 | ms | N | — | Y | Y |
| [9] | Y | 0.02 | s | N | — | Y | Y |
| [10] | Y | 0.17 | s | N | — | Y | Y |
| [12] | Y | N | | N | — | Y | Y |
| [19] | N | N | | Y | Y | N | N |
| [26] | N | 0.32 | s | Y | N | N | N |

### Conclusion

We present in this work a way of designing and fabricating universal bi-stable grippers that is capable of closing rapidly and picking up limp objects, mimicking the thumb-index finger pinching of human hands. The bi-stable mechanisms we use are termed “hair-clip mechanisms” or HCMs, due to their similarity with and inspiration from a snap hair clip. We depict the design principles using the theoretic solutions obtained from beam buckling theory, fabricate the grippers with PETG plastic sheets, and simulate the deformation of it using FE software to verify this method. Results show that replacing the end-effectors of the commercial gripper with our HCM fingers can increase the manipulation span by 2.7 times and the grasping speed by 10.9 times. Besides, the HCM fingers can apply gentle grasping forces on a variety of objects including fabrics. A comparison is given between this work and other soft grippers to show the role of this method.

### Manuscript 4: Novel Deformable Mechanism for Robotic Propulsion, Manipulation, and Other Devices

It is proved in our previous work that an HCM can be efficiently used as a skeleton and force amplifier for compliant fish robots and terrestrial crawlers and beat previous records with a three-fold and a five-fold improvement, respectively [16], [17]. The bi-stability of HCM plastic ribbons can increase the angular velocity of a robotic fishtail by about 3 times during snapping [16] and the dome-like structure of the ribbons from their buckled configuration can increase their bending rigidity by about 11 times [17]. All of these features contribute to the performance of our HCM gripper in this paper. Due to the same theory used, the shape and properties of HCM grippers can be derived similarly [16], [17], [22]. Thus, the timescale of the snapping process of the HCM fingers can be estimated as

$${t}_{*} = \frac{{( 2 l )}^{2}}{t \sqrt{E / {ρ}_{s}}} , \qquad ( 1 )$$

where l is the effective length of the half ribbon in FIG. 3, E is the material modulus, t is the thickness of the material, and ρₛ is the density of the material. The opening gap W between the two fingers has a dimension of

$$W = {L}_{f} + 2 \cdot u ( l ) = {L}_{f} - 2 \cdot \frac{{P}_{cr}}{{EI}_{η}} {\int }_{0}^{l} {\int }_{0}^{z} φ ( z ) ( l - z ) dz dz , \qquad ( 2 )$$

in which L_{f}=48.0 mm is the installation gap between the fingers, u(l) is the lateral deflection u(z) at z=l, and the critical load P_{cr} of the ribbon's lateral-torsional buckling and the lateral rotational angle φ are, respectively,

$${P}_{cr} = \frac{5.5618}{{l}^{2}} \cdot \sqrt{{EI}_{η} C} , \qquad ( 3 )$$

$$φ ( z ) = \sqrt{l - z} {A}_{1} {J}_{1 / 4} ( \frac{1}{2} \sqrt{\frac{{P}_{cr}^{2}}{{EI}_{η} C}} {( l - z )}^{2} ) , \qquad ( 4 )$$

C=Ght³/3 is the torsional rigidity of the ribbon, A₁ is a non-zero integration constant derived from energy conservation, J_{1/4} is the Bessel equation of order ¼, and I_{η}=h³t/12 is the area moment of inertia of the ribbon. The energy released in each grasp of the gripper equals the energy gap between the bi-states of the fingers which is

$${U}_{barr} = 6 {P}_{cr} \cdot D . \qquad ( 5 )$$

This energy will dissipate in friction and collision, resulting in high force and high speed.

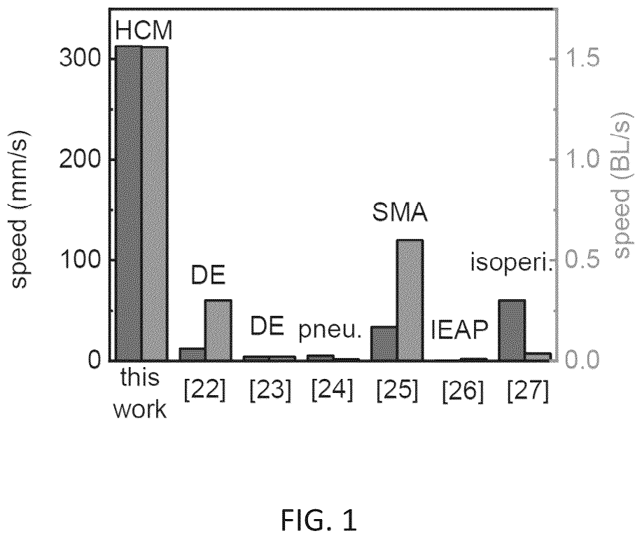

One can use the bi-stable HCMs to mimic the fabric grasping motion of human fingers as in FIG. 1C. To the best of the author's knowledge, this is the first soft gripper that can deal with both stiff and limp objects. The challenge of manipulating limp objects is due to the disparate criteria between grasping 2D objects and 3D objects, which is illustrated in FIG. 2. Before the “liftable” condition that friction 2 F·μₗₛ>object gravity G, picking up limp objects has two more preconditions: the friction force of the grasping should be larger than the friction force at the bottom of the fabric; the grasping force should be larger than the bottom friction plus the Euler's critical load of the fabric. We term the two preconditions as “manipulable” and “wrinklable” prerequisites.

Based on this theory, the properties of our bi-stable soft grippers are suitable for this task: the HCM fingers have a large opening gap W that is usually several times the actuation distance, offering enough space to wrinkle and grasp the cusp of the fabric, and the snap-through buckling can generate a large instant force Fₘₐₓ that is unusual in soft grippers, helping overcome friction and resistance. Moreover, bi-stability offers grasping force F without energy input, which is beneficial in long-term manipulation.

### Fabrication and Measurement

The HCM gripper is composed of two plastic HCM fingers (McMaster-Carr, 9536K), a 3D-printed clamping panel (Ultimaker S3, PLA), and a robotic arm (Trossen Robotics, WidowX), as shown in FIG. 1. An energy source of 12 V is needed for the operation of the actuators and microcontroller (Dynamixel, MX-64, MX-28, AX-12A, ArbotiX Robocontroller). Although multiple materials from paper to steel sheets can be used for HCM designs, we choose semi-rigid plastic material with a modulus of E=1730 MPa [≠] to ensure safe interaction and easy fabrication. The HCM fingers are laser cut (Thunder Laser, Nova 51) PETG ribbon with a width of h=15 mm, a thickness of t=0.762 mm, and an effective half-length of l=93.7 mm. To achieve the prestressed configurations, they are pin-locked with press-fit rivets (McMaster-Carr, 97362A), and are coated with silicone rubber sheets (Smooth-On Inc., Ecoflex 10) to increase the friction coefficient μₗₛ. The dome-like configuration (FIG. 1A) of the HCM fingers offers the rigidity and force needed to grasp the objects. Thus, no additional energy is needed to maintain the closing mode of the gripper.

### Holding Force

With a digital force gauge (Mxmoonfree, ZMF-50N), FIG. 1E shows the magnitude of pinching force with respect to the shapes, dimensions, and materials of the objects. Due to the silicone rubber coating (FIG. 1D) and the compliant and curved shape of the HCM fingers, two mechanisms contribute to the holding force: friction and geometric interlocking [6]. For a prestressing level of D=40 mm, the gripper has grasping forces that are 2.0-4.5 N for most rigid objects with the two pinching fingers. Though, the coin and the coin-like disc present challenges to the gripper with their small dimensions in the vertical direction. Only 40% and 50% success rates are observed in picking them up based on ten trails, respectively, and low average holding forces of 0.41 N and 0.87 N are obtained (FIG. 1F). The force of picking up a t-shirt (1.65 N) is larger than that of a single layer of fabric (1.32 N), as is shown in FIG. 1F. And due to its self-weight, t-shirt only can be picked up by the gripper in 50% of the cases. Despite that, the HCM gripper has a success rate of 100% in picking up objects like columns, cubes, pyramids, spheres, and single-layer fabric sheets.

A more detailed summary of grasping fabrics and leather samples is shown in FIG. 3A. The holding forces range from 0.5-1.3 N, dependent on the thickness and texture of the material, and measured from the total lifting force minus the self-weight. In general, the holding forces for 2D objects are smaller than holding geometric shapes like spheres and cubes. This is because only a small cusp or wrinkled part of the fabric is being held (FIG. 2A) and limp materials can easily slip off. For holding heavier fabric sheets, multiple fingers or HCM arrays can be used.

### Span and Speed

For pinching grippers, the span is important because it determines how large objects the gripper can manipulate. And in the case of fabric grasping, a larger span makes the grasping of limp objects easier since it quadratically decreases the force Fₘₐₓ needed to buckle the sheets and also enables the gripper to take hold of a larger cusp or more wrinkles to have a firmer grasp. On the other hand, the speed of grasping is also important for the efficiency of the garment industry since a large portion of the time is spent on manipulating raw materials. However, span and speed usually contradict each other for traditional grippers since it generally takes longer to cover a larger distance. Here, we demonstrate that by leveraging bi-stability, our soft gripper can take a grip rapidly, regardless of the large span.

The simulated results of grip span W vs, the prestressing level D are shown in FIG. 3B, together with the theoretical and experimental outcomes. The finite-element (FE) analyses of the configuration (FIG. 1A and FIG. 3B) of the in-plane prestressed HCM are created using ABAQUS/CAE and solved with ABAQUS/Standard. All simulations use about 4600 shell element S4R or S3R and the material is assumed to be linear elastic with Young's modulus (E) of 1730 MPa and a Poisson ratio (v) of 0.38.

Based on the comparison, the simulative results are quite close to the measurements, giving an error of about 5%. And the theoretical solutions calculated from Eq. (2) are within a 10% error compared to the measurements. The span of our HCM gripper is several times larger than that of the original robotic gripper, which is only 32 mm (FIG. 3B). In some experiments, an inward tilting angle is applied when installing the HCM fingers to increase the holding force, which can decrease the gripper span (FIG. 3B).

For example, FIG. 3C presents an HCM gripper with a span of W=86 mm and a tilting angle of 10° that can snap during a short amount of time of 45.8±6.7 ms, close to the theoretical solutions of 53 ms calculated from Eq. (1), while the closing of the traditional gripper with a span of W=32 mm usually takes 0.5 s. The HCM is 10.9 times faster than the reference gripper and can vastly increase the grasping efficiency in the garment industry. In one example, we demonstrated a 2 Hz open-close cycling of the HCM gripper and the major limitation for further increasing the cycling frequency of the gripper is the rotational speed of the motor (59 rev/min, DYNAMIXEL, AX-12A). The trajectory of the HCM fingers is a curved one, in which the HCM fingers first slightly open during the elastic energy storing stage and then suddenly close, similar to the motion of human fingers in a thumb-index finger pinching, while the reference gripper moves straightly with a uniform velocity.

### Fatigue

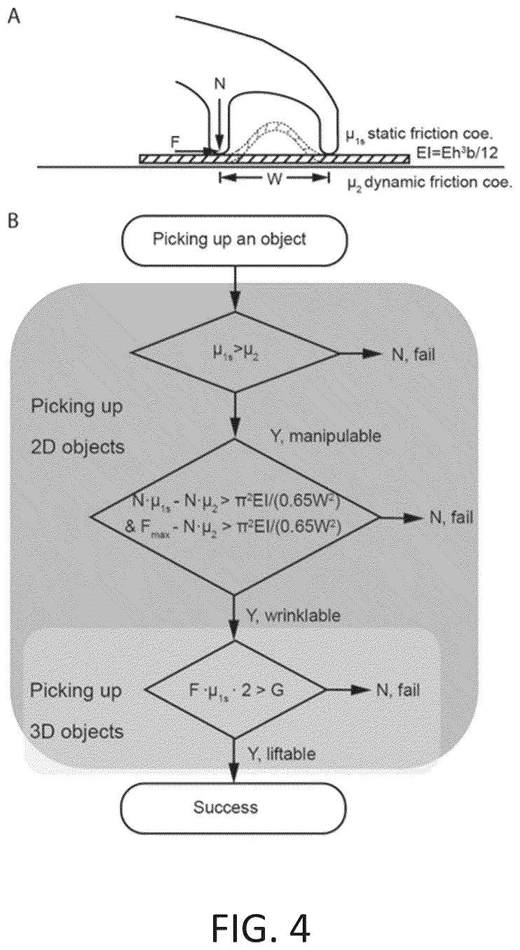

For compliant mechanisms that incorporate prestressing and bi-stability, the fatigue problem of the material is a consideration, since their motion comes from the bending deformation of flexible parts which leads to stress at those locations [24]. In FIG. 4, we present the fatigue lives of HCM fingers with prestressing D=20 mm made of PETG plastic sheets of thickness t=0.015-0.06 inch. It is found that the PETG plastic sheets can withstand 20000˜ 460 times cycles depending on the thickness, and that tiny cracks appear mostly at the corner of the HCM fingers. The disclosed components can be made from, for example, polymers, metals, carbon fiber, and other materials and composite materials.

### Application

To demonstrate the functionality of the proposed strategy of using pre-stressed plastic HCMs as end-effectors in robotic manipulation, the performance of the motor-driven HCM gripper with a commercial robotic arm and a pneumatic variant of the HCM gripper is presented in this section.

### Manipulation of Fabrics

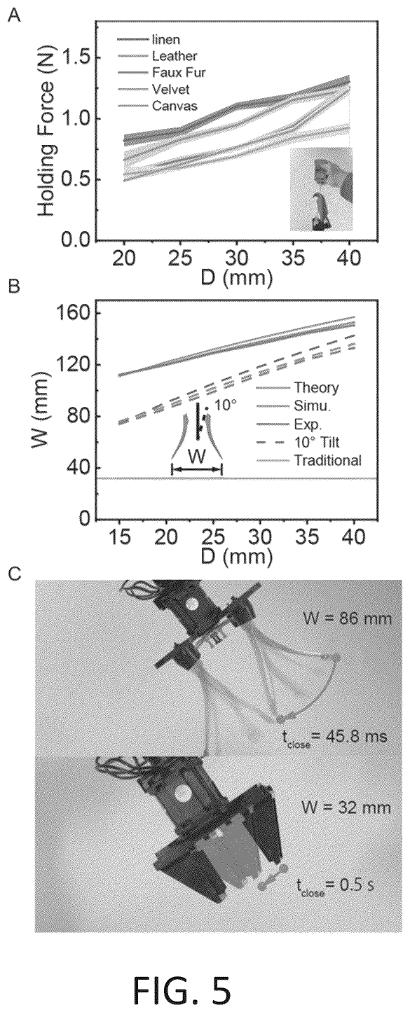

To challenge the gripper's capacity for fabric manipulation and to increase the efficiency of an actual garment production process, we design this test to exhibit the gripper's ability to pick up a single sheet of fabric from a stack of multiple sheets. The picking-up experiment was carried out with 20×20 cm² cotton squares. In the demonstration, the gripper moves down to the stack, picks up and removes the top fabric, and places it to the side. Success is defined when the gripper holds only the top single sheet in the stack and failure otherwise. This process is illustrated in FIGS. 5A and 5B. The gripper repetitively picks up the top single fabric sheet 10 times, and a success rate of ˜80% is observed. On the other hand, the traditional gripper is unable to pick up fabric due to its small span (FIG. 5C).

### Pneumatic Gripper

To further demonstrate the compatibility of HCM end-effectors, we build a pneumatic version of it, as in FIG. 5D-E. Similar to the motor-driven version, this pneumatic HCM gripper has a minimalistic design that includes two pneumatic-actuated fingers and a 3D-printed panel holding the fingers in position. The pneumatic soft bending units are fabricated with 3D-printed molds and a silicone rubber casting process [16] (Smooth-On Inc., Dragon Skin 20). Upon an actuation pressure of ˜150 kPa. It does thumb-index finger pinching and picks up a piece of initially-flat soft fabric just like the motor-driven one does. Besides, the pneumatic HCM gripper weighs 15 g and can pick up objects of 44 g (FIG. 5C), which is three times its self-weight. Similarly, the pneumatic variant also only consumes energy when a mode transition is needed, due to its bistable nature.

### Comparisons

To explain the role that the HCM gripper plays in the field of soft grippers, a comparison among the proposed HCM soft gripper and a few representative soft grippers [4]-[6], [8]-[10], [12], [19], is given in Table I. The table summarizes the grippers ability to pick up objects with various shapes (universal), to grip rapidly, to manipulate fabric, to have a large span, and to harness bistability. It also mentions whether the gripper uses piercing needles if it can deal with fabrics. Compared to others, the HCM gripper possesses an overall advantage in these mechanical properties, due to its bistable structure and its similarity with human fingers in shape and function. Besides, the HCM fingers are easier to fabricate and assemble than most other grippers. It is also noted that, compared to the commercial reference gripper that shares the same controlling system and the same hardware platform, the HCM modification enables the system to work as a bistable soft gripper with the ability to pick up fabric and significant increases in span and grasping speed.

Comparison among the HCM gripper, reference commercial gripper, and other soft gripper studies:

| | | Fast | | Fabric | Non- | Large | Bi- |
|---|---|---|---|---|---|---|---|
| | Universal | Grasping | | Picking | Piercing | Span | Stable |
| This Work | Y | 46 | ms | Y | Y | 86 mm | Y |
| Ref. | Y | 0.5 | s | N | — | 32 mm | N |
| [4] | N | N | | N | — | N | N |
| [5] | Y | N | | N | — | Y | N |
| [6] | Y | N | | N | — | Y | N |
| [8] | N | 112 | ms | N | — | Y | Y |
| [9] | Y | 0.02 | s | N | — | Y | Y |
| [10] | Y | 0.17 | s | N | — | Y | Y |
| [12] | Y | N | | N | — | Y | Y |
| [19] | N | N | | Y | Y | N | N |
| [20] | N | 0.32 | s | Y | N | N | N |

### SUMMARY

Here is presented a way of designing and fabricating universal bi-stable grippers that is capable of closing rapidly and picking up limp objects, mimicking the thumb-index finger pinching of human hands. The bi-stable mechanisms are termed “hair-clip mechanisms” or HCMs. We depict the design principles using the theoretic solutions obtained from beam buckling theory, fabricate the grippers with PETG plastic sheets, and simulate their deformation using FE software to verify this method. Results show that replacing the end-effectors of the commercial gripper with our HCM fingers can, for example, increase the manipulation span by 2.7 times and the grasping speed by 10.9 times. Further, the HCM fingers can apply gentle grasping forces on a variety of objects including fabrics. A comparison is given between this work and other soft grippers to show the role of this method.

### Manuscript 5: Designing a Hair-Clip Inspired Bistable Mechanism for Soft Fish Robots

Soft and compliant robotics is an emerging field that focuses on designing and constructing robots with soft or deformable materials. The inherent softness of the material used enables these robots to mimic natural movements and interact with their environment in a novel way. Soft robotic fish, in particular, have garnered significant attention due to their potential in non-intrusive underwater exploration and environmental monitoring. Unlike traditional propeller-driven underwater vehicles, soft fish robots are usually driven by fluidic or electroactive polymer actuators and locomote through traveling sinusoidal waves that undulate their bodies. For example, Marchese et al., Katzschmann et al., Marchese et al., and Katzschmann et al, present the design, fabrication, control, and oceanic testing of a type of soft robotic fish that is self-contained and capable of rapid locomotion. Their fish robot swims in three dimensions and can monitor aquatic life and environments. Li et al, and Li et al, design and fabricated a ray fish-inspired soft swimmer actuated by dielectric-elastomer that is able to locomote at high speed and sustain high water pressure in the Mariana trench. Zhang et al, study global vision-based formation control of soft robotic fish swarm.

While soft robotic fish show great promise, several challenges remain. First of all, the highest speed achieved by this type of fish robot is only about 0.5˜0.7 BL/s. Others may have demonstrated faster speed but are not adequate in a tetherless situation. Second, the performance of such robots is significantly influenced by their empirical design and manual fabrication. In recent years, it has been noted that energy-storing-and-releasing mechanisms can significantly increase the moving speed and strength of robots and organisms, addressing the low-velocity problem of soft robotics. For instance, Hawkes et al. designed and fabricated a jumping robot that stores and releases multiplied work to achieve a height of 30 meters; Pal et al, present prestressed pneumatic soft actuators that recover at a short timescale of ˜ 50 ms through energy storing and releasing. Smith et al, study the beaks of hummingbirds that close in tens of milliseconds through an appropriate sequence of muscle actions. Forterre et al, analyze the rapid closure of the Venus flytrap and show that the snap-buckling instability plays an important role. Meanwhile, the use of semi-rigid materials, 2D materials, and 3D-printing technologies profoundly changed the design and fabrication methodology of soft robotics.

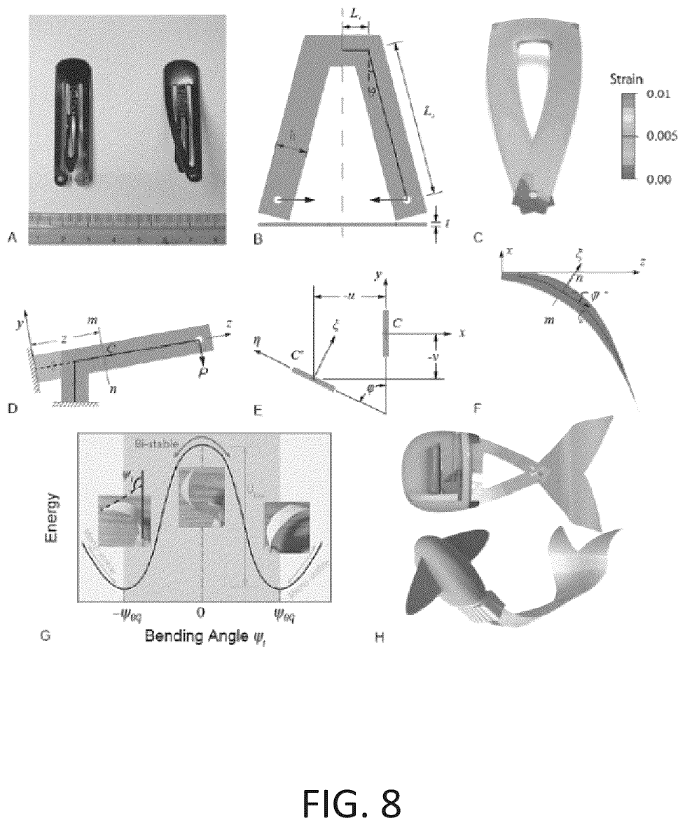

We propose to use prestressed bistable mechanisms to solve these problems. In our previous work, a type of in-plane prestressed bistable hair-clip-like mechanism is designed, fabricated, and analyzed, which we term hair clip mechanism (HCM, FIG. 8). HCMs have a stiffness about 8-11 times higher than their unassembled precursor (we borrow the terms “precursor” and “postcursor” to distinguish between the “unassembled” and “assembled” HCM ribbons, respectively), which enables their usage as the robotic skeleton and motion-transmission mechanism at the same time. The bistability of HCMs unlocks their function as force or power amplifiers that improve the performance of soft robots. For example, we demonstrated a tetherless robotic fish that is capable of swimming at a speed of 2.03 BL/s and a galloping robotic crawler that has a speed of 1.56 BL/s. Both are among the highest rates achieved among their kindred. Besides, most HCM parameters can be derived from an approximated mathematical model for HCMs with acceptable errors, which provides us with a systematic design algorithm for HCM soft robots.

The idea of using snap-through buckling mechanisms as robotic propulsion also appeared in others' work. However, the structures used only show their force-amplifying function but don't have high efficiency or convenience, nor a detailed theory or designing algorithm is proposed for their use. Also, most of them are in tethered situations. The use of HCM will probably solve these problems.

### HCM Theory

The construction, operation, and application of the hair-clip mechanism (HCM) are depicted in FIG. 8. By connecting the two extremities of an angled plastic strip, a bistable mechanism resembling a hair clip emerges. For mathematical solution derivation, we define the coordinate systems and variables in FIGS. 8B and 8D-8G. The displacement components u, v, and φ are gauged at centroid C of a random section mn along the x, y, and z axes (fixed space coordinates). The signs of them adhere to axis directions and the right-hand rule. The ξ, η, and ζ axes (follower coordinates) are established through the altered centroid C′ of section mn, aligning with the main axes of the deformed configuration. Using the small deflection assumption, Euler beam theory, and considering the angled ribbon as a direct cantilever beam with a constant rectangular cross-section (FIG. 8D), the assembly process is expressed by mathematical equations below:

$${EI}_{ξ} \frac{{d}^{2} v}{{dz}^{2}} + P ( l - z ) = 0 \qquad ( 1 )$$

$${EI}_{η} \frac{{d}^{2} u}{{dz}^{2}} + P φ ( l - z ) = 0 \qquad ( 2 )$$

$$- C \frac{d φ}{dz} + P ( l - z ) \frac{du}{dz} - P ( {u}_{1} - u ) = 0 \qquad ( 3 )$$

Here, EIᵢ=E×(widthᵢ)×(heightᵢ)³/12 represents the flexural rigidity along the i axis (FIG. 8D-8F), l=L₁+L₂ signifies the strip's half-length, C=GJ=hb³G/3 denotes the torsional rigidity of the thin section mn, u₁ is the horizontal deflection at the beam end z=l, G=E/2/(1−v) is the shear modulus, and v the Poisson ratio. Differentiating Eq. (3) concerning z and incorporating in Eq. (2) gives

$$C \frac{{d}^{2} φ}{{dz}^{2}} + \frac{{{P}^{2} ( l - z )}^{2}}{{EI}_{η}} φ = 0 \qquad ( 4 )$$

The general solution of Eq. (4) is:

$$φ = \sqrt{s} [ {A}_{1} {J}_{1 / 4} ( \frac{{β}_{1}}{2} {s}^{2} ) + {A}_{2} {J}_{- 1 / 4} ( \frac{{β}_{1}}{2} {s}^{2} ) ] \qquad ( 5 )$$

where s=l−z, J_{1/4} and J_{-1/4} represent the Bessel functions of the first kind of order ¼ and −¼, respectively, and

$${β}_{1} = \sqrt{\frac{{P}^{2}}{{EI}_{η} C}} . \qquad ( 6 )$$

Given the ribbon's symmetry, the small deflection premise, and the boundary condition:

$${φ \vert}_{s = 0} = 0 , \qquad ( 7 )$$

we can infer that the integration constant A₂ equals 0, which reduces Eq. (5) to only one term:

$$φ ( z ) = \sqrt{l - z} {A}_{1} {J}_{1 / 4} ( \frac{1}{2} \sqrt{\frac{{P}_{cr}^{2}}{{EI}_{η} C}} {( l - z )}^{2} ) , \qquad ( 8 )$$

in which A₁ is a non-zero integration constant that can be determined from energy conservation. The value of Pₑᵣ can be derived from the other boundary equation:

$$φ ( 0 ) = \sqrt{l} {A}_{1} {J}_{1 / 4} ( \frac{1}{2} \sqrt{\frac{{P}_{cr}^{2}}{{EI}_{η} C}} {l}^{2} ) = 0 \qquad ( 9 )$$

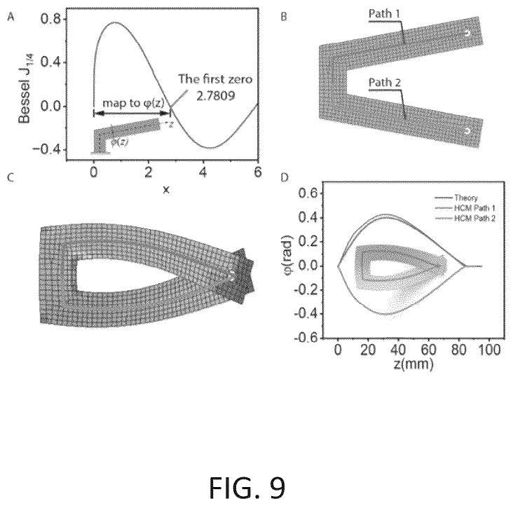

Since A₁ is a non-zero constant, the J_{1/4} term must be zero. At the same time, the physical meaning of the J_{1/4} term is the configuration of the deformed ribbon (with a simple mapping), which should only have one zero point because of the lack of lateral support along the half-ribbon path. The profile and physical meaning of the Bessel function is shown in FIG. 9A. Plugging the first zero into Eq. (9) yields

$$\frac{1}{2} \sqrt{\frac{{P}_{cr}^{2}}{{EI}_{η} C}} {l}^{2} = 2.7809 \qquad ( 10 )$$

and thus,

$${P}_{cr} = \frac{5.5618}{{l}^{2}} \sqrt{{EI}_{η} C} . \qquad ( 11 )$$

Plugging Eq. (10) into Eq. (8) gives the analytical expression of

$$φ ( z ) = \sqrt{l - z} {A}_{1} {J}_{1 / 4} ( 2.7809 {( \frac{l - z}{l} )}^{2} ) . \qquad ( 12 )$$

To decide A₁'s value and subsequently φ, we incorporate an energy conservation equation, which states that the structure's total elastic strain energy must equate to the external load's work. With the membrane strain energy disregarded, we deduce that:

$$\begin{matrix}U = \frac{1}{2} {\int \text{?}}_{0} [ \frac{{M}_{η}^{2}}{{EI}_{η}} \text{?} {GJ ( \frac{d φ}{dz} )}^{2} ] dz \\ = \frac{1}{2} {\int \text{?}}_{0} [ {{P}_{cr}^{2} ( l - z )}^{2} {sin}^{2} φ / {EI}_{η} \text{?} {GJ ( \frac{d φ}{dz} )}^{2} ] dz\end{matrix} \qquad ( 13 )$$

$$V = {P}_{cr} \cdot D = {P}_{cr} \cdot {L}_{2} ( {sin}^{- 1} \frac{1}{{γ}_{s}} \text{?} θ ) \qquad ( 14 )$$

$$and U = V \qquad ( 15 )$$

$$\text{?} \text{indicates text missing or illegible when filed}$$

in which U represents the elastic strain energy, Mη is the beam's moment along the η axis, V signifies the external work by Pcr, and D denotes the prestressing distance. The value of A1 hinges on the value of γₛ=L₂/L₁ and θ (FIG. 8) and typically ranges between 0.09 and 0.10.

### Validation and Application

The verification of Eq. (12) is presented with the help of the Abaqus FE simulation (FIG. 9B-9D). Finally, by integrating Eq. (12) into Eq. (2), we can determine section mn's out-of-plane bending angle ψ from

$$ψ ( z ) \approx \frac{du}{dz} = - \frac{{P}_{cr}}{{EI}_{η}} {{\int }^{z}}_{0} φ ( l - z ) dz \qquad ( 16 )$$

and the translational displacement

$$u ( z ) = {{\int }^{z \vert}}_{0} \text{?} φ ( s ) ds . \qquad ( 17 )$$

$$\text{?} \text{indicates text missing or illegible when filed}$$

We validated Eq. (16) by comparing it with experiments and corresponding FE simulations in [2]. The energy barrier between the bi-states of the HCM can be approximated as [2]

$$U \text{?} = 3 {P}_{cr} \cdot D \qquad ( 18 )$$

$$\text{?} \text{indicates text missing or illegible when filed}$$

Assuming Hooke's law (linear elasticity), when the servo deforms HCM, the peak torque required to actuate the HCM can be calculated as

$$T \text{?} = 2 U \text{?} \cdot L \text{?} / 2 u ( {L}_{1} )$$

$$\text{?} \text{indicates text missing or illegible when filed}$$

in which L₁ is the length denoted in FIG. 8B, and Lₕₒᵣₙ is the length of the horn that goes with the servo. Usually, the design operational frequency is the key parameter that determines the performance of the HCM robot. It can be calculated as

$${f}_{design} = min \{ \begin{matrix}{f}_{m , HCM} = 1 / 2 t \text{?} , \\ {f}_{m ,} \text{?} = speed / 4 u ( {L}_{1} )\end{matrix} \} , \qquad ( 20 )$$

$$\text{?} \text{indicates text missing or illegible when filed}$$

in which t* is the timescale of the HCM snapping that is estimated as

$$t \text{?} = \frac{{( 2 l )}^{2}}{t \sqrt{E / {ρ}_{s}}} . \qquad ( 21 )$$

$$\text{?} \text{indicates text missing or illegible when filed}$$

### Designing Algorithm

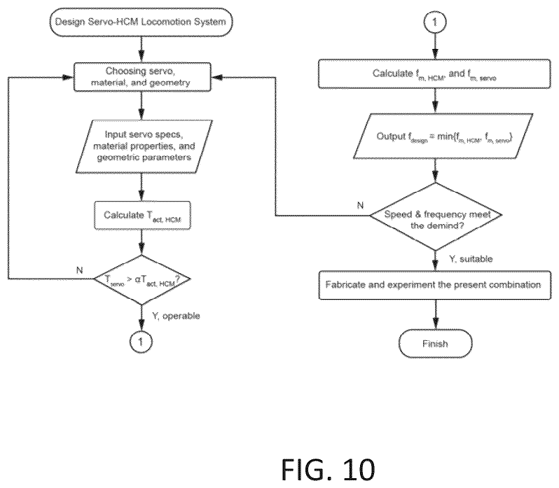

According to the HCM theory, the algorithm for designing a servo-HCM locomotion system fish robots can be illustrated in FIG. 10. Usually, the most important and time-consuming procedure is to look for correct combinations of servo, material, and shapes, according to our experience with the two fish robots. Typical materials include plastic, CFRP, and steel, whose related properties are given in Table I—their high tensile modulus and elastic limit enable them to withstand repeating loads and strain. The specifications of common servo motors are provided in Table II, in which Tₛₑᵣᵥₒ denotes the stall torque. A design factor of α>1 is suggested to ensure the successful servo-driven snap-through buckling of the HCM. In most situations, the speed of the fish robots is positively correlated with the undulating frequency. Thus, the iteration of HCM's geometry to configure the undulating frequency and strength offers a simple fix.

TABLE I
Dimensions and mechanical properties of typical HCM materials

| | Tₛₑᵣᵥₒ | speed | weight | Lₕₒᵣₙ | f_{m, servo} |
|---|---|---|---|---|---|
| | (mm · N) | (rad/s) | (g) | (mm) | (Hz) |
| MG90S | 245 | 10.5 | 14 | 10 | 4.5 |
| B24CLM | 588 | 12.3 | 22 | 20 | 6.15 |
| A66BHLW | 3234 | 15.4 | 66 | 25 | 13.6 |
| A06CLS | 294 | 20.1 | 7 | 13 | 17.0 |
| DS3230MG | 3381 | 6.16 | 58 | 25 | 3.08 |
| SG92R | 245 | 10.5 | 9 | 10 | 4.5 |
| ZOSKAY | 3430 | 9.5 | 60 | 25 | 4.76 |

### Parametric Analysis

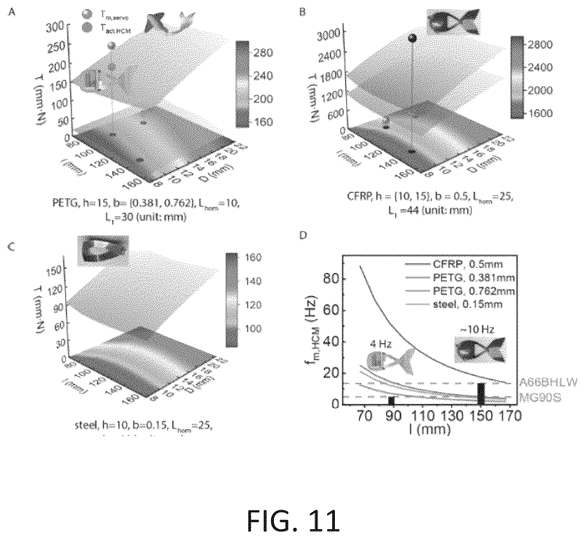

The designing logic and parametric influence of HCM fish robots are further discussed in FIG. 11. The major elements that influence the peak torque (T_{act, HCM}) required to actuate the snapping-through of the HCM are material types and geometric dimensions half ribbon length l, the prestressing distance D, ribbon height h, ribbon thickness t, horn length Lₕₒᵣₙ, and HCM half width L₁. The required actuation torque of HCM is proportional to D, h, and b³ yet is less relevant to the HCM ribbon length 2l since the increase of l not only decreases energy barrier U_{barr} but also decreases u(L₁), the required actuation displacement of the HCM snap-through.

Three prototypes are juxtaposed in FIGS. 11A and 11B to compare the design theory with actual specifications. The pink and coral fish robots are made from PETG plastic HCMs, whose parameters are shown. The pink one has a geometry of b=0.381 mm, l=87.5 mm, and D=17.15 mm, which corresponds to a required torque of T_{act, HCM}=28.3 mm. N; the coral fish robot has b=0.762 mm, 1=87, D=11.75 mm, corresponding to T_{act, HCM}=188.7 mm· N and thus a design factor α_{coral}=245/188.7=1.30 due to the use of an MG90S. The black fish robot prototype is made from CFRP HCM with h=10 mm, l=137 mm, and D=10 mm, and thus a design factor α_{carbon}=3234/1177=2.75 with A66BHLW as the driving servo. The T_{act,HCM} profile of steel HCM is plotted in FIG. 11C.

The frequency analysis is illustrated in FIG. 11D. It is shown that the limiting condition is usually the speed of the servos: the coral fish has a maximum HCM frequency of f_{m, HCM}=14.8 Hz, while the MG90S servo operates at a maximum of T_{m,servo}=4.5 Hz. The actual undulation of it is 0˜ 4 Hz. The CFRP fish robot has f_{m, HCM}=21.1 Hz and T_{m,servo}=13.6 Hz, and the actual operation is 0˜10 Hz. To further increase the flapping frequency and swimming speed in the future, a DC motor-driven HCM system would be very beneficial.

### Conclusion

The research presented delves into the innovative application of the Hair clip mechanism (HCM) to enhance the capabilities of soft robotics. The HCM, an in-plane prestressed bistable mechanism, offers a myriad of advantages, including high rigidity, mobility, repeatability, and ease of design and fabrication. This work, building upon our prior research, explores the design of an HCM robotic propulsion system using materials such as PETG plastic, CFRP, and steel. Through comprehensive analysis, the influence of various parameters like dimensions, material types, and servo motor specifications on the HCM's performance is elucidated.

Our findings underscore the potential of HCMs in addressing the challenges faced by soft robotic fish, particularly in achieving higher speeds and more efficient locomotion. The systematic design algorithm provided for HCM robots, backed by mathematical models, paves the way for more predictable and efficient robot designs.

### Manuscript 6: CarbonFish: A Bistable Underactuated Compliant Fish Robot Capable of High-Frequency Undulation

Soft and compliant robotics represents an advancing domain in robotics research, emphasizing the design and development of robots utilizing soft and deformable materials. The intrinsic flexibility of these materials facilitates robots to replicate biomechanical movements, allowing for adaptive interactions with their environment. Specifically, soft robotic fish have obtained significant attention, given their prospective applications in non-intrusive underwater exploration and systematic environmental monitoring8. Contrary to traditional propeller-driven underwater vehicles, these biomimetic robots usually employ fluidic or electroactive polymer actuators, propelling themselves via repeated undulations. Several studies underscore the potential of this technology. For instance. Marchese et al., detail the design, fabrication, and experimental verification of a complete, tetherless, pressure-operated soft robotic platform. Katzschmann et, al, present an autonomous soft-bodied robotic fish that is hydraulically actuated and capable of sustained swimming in three dimensions. Marchese et al, describe an autonomous soft-bodied robot that is both self-contained and capable of rapid, continuum-body motion. Katzschmann et al. have elucidated the design, fabrication, control mechanisms, and marine evaluations of a particular soft robotic platform. This fish robot exhibits a lifelike undulating tail motion enabled by a soft robotic actuator design that can potentially facilitate a more natural integration into the ocean environment, demonstrating controlled navigation in the natural aquatic environments and proficiency in conducting detailed marine ecological assessments. Berg et al. 12 study OpenFish. A detailed description of the design, construction, and customization of the soft robotic fish is presented. Other influential works include Li et al., Li et al., and Lin et al.

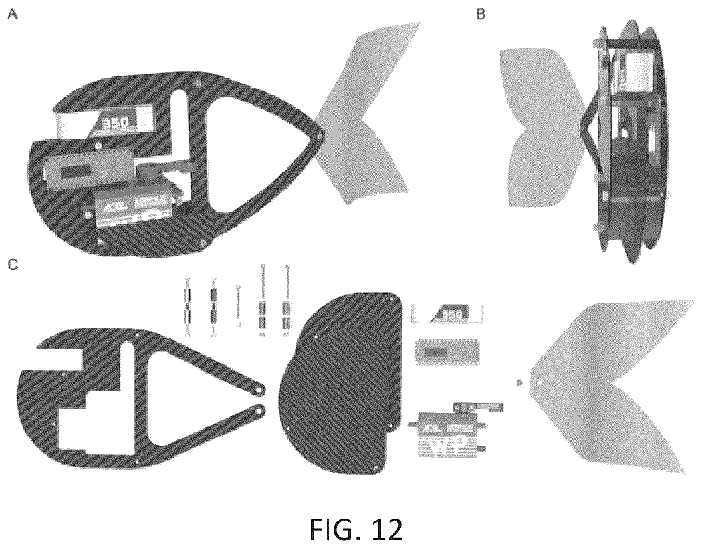

While soft robotic fish show great promise, several challenges remain. First of all, the highest speed achieved by this type of fish robot is only about 0.58˜ 0.7 BL/s. Others may have demonstrated faster speed but are not adequate in a tetherless situation. Second, the performance of such robots is significantly influenced by their empirical design and manual fabrication. We propose to use prestressed bistable mechanisms, a kind of energy-storing-and—releasing mechanism, to solve these problems. In our previous work, a type of in-plane prestressed bistable hair-clip-like mechanism is designed, fabricated, and analyzed, which we term hair clip mechanism (HCM, FIG. 12). HCMs have a stiffness about 8-11 times higher than their unassembled precursors (the terms “precursor” and “postcursor” are used for the “unassembled” and “assembled” HCM ribbons, respectively), which enables their usage as the robotic skeleton and motion-transmission mechanism meanwhile. Similar bistable mechanisms are studied in others' work, but are in tethered situations and only present their force-amplifying ability.

The body and/or caudal fin (BCF) undulation, featuring a backward traveling wave with the largest wave amplitude at the fish tail, is the most popular bionic swimming pattern due to its high speed and energy efficiency. However, the robot needs at least one or two among the three conditions of multiple actuators, cable-driven multi-joint BCF, and smart elastomeric body to achieve BCF locomotion, which is quite demanding and increases the difficulty of waterproofing and cannot ensure high performance due to the inefficient mechanism and the variation of fabrication skills. Barrett et al, designed a fixed cable-driven fish robot platform with 6 brushless motors to demonstrate that an undulatory streamlined compliant body is much more energetically efficient than a rigid body. Clapham and Hu developed a series of motor-driven tethered/untethered fish robots, iSplash-I, iSplash-MICRO, iSplash-II, and iSplash-OPTIMIZE, that range from 50-620 mm in length and that can operate at 5-20 Hz, providing a lab-condition speed of 3-11.6 BL/s (up to 3.7 m/s) that is comparable to real fish locomotion speed.

It is observed that as undulatory frequencies are raised, the swimming fish or robots continue to increase velocity regardless of the frequency regions, prototype difference, or swimming patterns, indicating that only an altered frequency is required to increase swimming speed. Thus, we provide CarbonFish (FIG. 12), a single-actuated fish robot with half-rigid materials, minimalistic design, bistable HCM actuation, fishlike BCF swimming, and up-to-10 Hz undulation, to address the speed and energy efficiency problems. Moreover, the HCM bi-stable BCF locomotor system generates a novel undulation pattern that has an energy efficiency close to the sinusoidal waving and a 2-3 times higher aquatic propulsion than other patterns. These facts can provide insights into fish-inspired locomotion, improving the efficiency and capabilities of aquatic robots.

### Working Principles

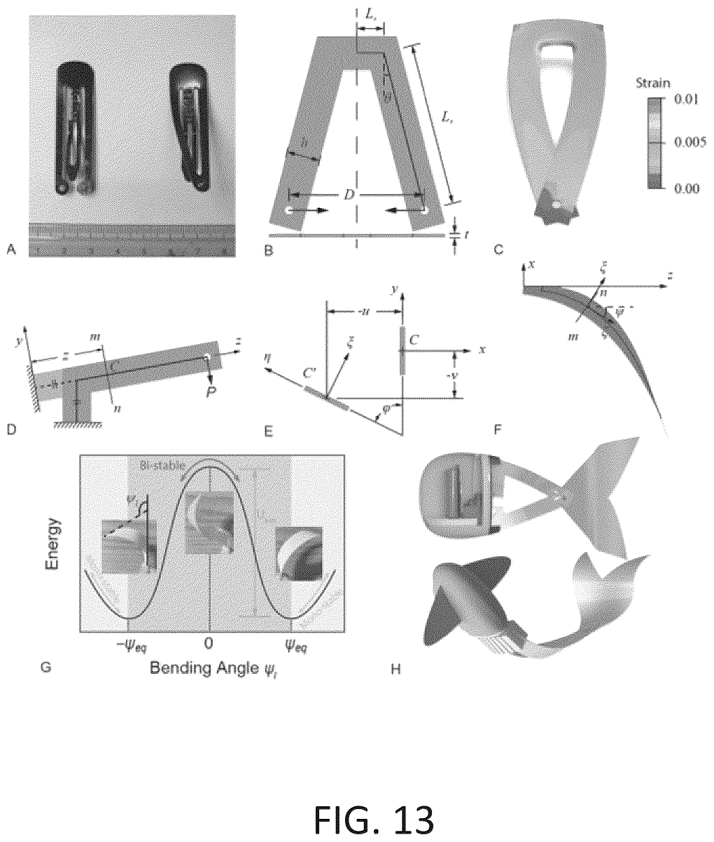

The inspiration, assembly, mathematical modeling, and robotic applications of HCM are depicted in FIG. 13. Like hair clips, by pinning together the two extremities of an angled strip made of plastic, paper, or metal sheets, a bistable mechanism forms. HCM has features like stiffened rigidity, fast morphing, and force amplifying due to the lateral-torsional buckle and snap-through effect, which store and release suddenly elastic energy by actuation. Thus, we look forward to seeing how HCM functions as a load-bearing skeleton, motion transmission system, and high-speed actuator.

### HCM Theory

For analytical derivation, we define the coordinate systems and variables in FIGS. 13B and 13D-13F. The displacement components u, v, and φ are gauged at centroid C of a beam section mn along the x, y, and z axes (undeformed coordinates). The signs of them adhere to axis directions and the right-hand rule. The ξ, η, and ζ axes (deformed coordinates) are established through the altered centroid (of section mn, aligning with the main axes of the deformed configuration. With assumptions of small deflection, Euler beam, and treating the angled half ribbon as a straight cantilever beam (FIG. 12D), the torsional angular displacement φ (FIG. 13E) of a typical HCM can be depicted by the equation

$$φ ( z ) = \sqrt{l - z} {A}_{1} {J}_{1 / 4} ( \frac{1}{2} \sqrt{\frac{{P}_{cr}^{2}}{{EI}_{η} C}} {( l - z )}^{2} ) , \qquad ( 1 )$$

in which l=L₁+L₂ is the half ribbon length, A₁ is a non-zero integration constant that can be determined by considering energy conservation law, J_{1/4} is the Bessel function of the first kind of order ¼, P_{cr} is the critical load of the lateral-torsional buckling during the assembly of HCMs (FIG. 13D), EIη=Eh³t/12 is the out-of-plane flexural rigidity of the ribbon, C=Ght³/3 is the approximated torsional rigidity of a beam section whose h≥10t, E is the Young's modulus, G=E/2(1+v) is the shear modulus of the HCM, h is the ribbon width, t is the thickness of the sheets, and v is the Poisson's ratio. The value of the P_{cr} can be derived from the boundary equation, i.e.,

$$φ ( 0 ) = \sqrt{l} {A}_{1} {J}_{1 / 4} ( \frac{1}{2} \sqrt{\frac{{P}_{cr}^{2}}{{EI}_{η} C}} {l}^{2} ) = 0 \qquad ( 2 )$$

Since A₁ is a non-zero constant, the J_{1/4} term must be zero. At the same time, the physical meaning of the J_{1/4} term is the configuration of the deformed ribbon, which should only have one zero point because of the lack of lateral support along the half-ribbon path. Plugging the first zero of J_{1/4} into Eq. (2) yields

$$\frac{1}{2} \sqrt{\frac{{P}_{cr}^{2}}{{EI}_{η} C}} {l}^{2} = 2.7809 \qquad ( 3 )$$

and thus,

$${P}_{cr} = \frac{5.5618}{{l}^{2}} \cdot \sqrt{{EI}_{η} C} . \qquad ( 4 )$$

Plugging Eq. (4) into Eq. (1) gives the analytical expression of

$$φ ( z ) = \sqrt{l - z} {A}_{1} {J}_{1 / 4} ( 2.7809 {( \frac{l - z}{l} )}^{2} ) . \qquad ( 5 )$$

With A₁ solved from energy conservation, the tip bending angle of the HCM is

$${ψ}_{l} = \frac{{P}_{cr}}{{EI}_{η}} {{\int }_{0}}^{l} φ ( l - z ) dz , \qquad ( 6 )$$

and the translational displacement

$$u ( z ) = {{\int }_{0}}^{z} φ ( s ) ds . \qquad ( 7 )$$

The energy barrier between the bi-states of the HCM can be approximated as

$${U}_{bar} = 3 {P}_{cr} \cdot D , \qquad ( 8 )$$

in which D is the prestressing displacement of FIG. 13B. Assuming Hooke's law (linear elasticity), when the servo deforms HCM, the maximum torque required to snap the HCM can be calculated as

$${T}_{act , HCM} = 2 {U}_{barr} \cdot {L}_{horn} / 2 u ( {L}_{1} ) \qquad ( 9 )$$

in which Lₕₒᵣₙ is the length of the servo horn, and L₁ is the core section length of HCM in FIG. 13B. The torque capacity of the servo is taken as the stall torque. The frequency capacity of the servo-HCM system can be calculated as

$${f}_{design} = min \{ \begin{matrix}{f}_{m , HCM} = 1 / 2 t * , \\ {f}_{m , servo} = speed / 4 u ( {L}_{1} )\end{matrix} \} , \qquad ( 10 )$$

in which t* is the timescale of the HCM snapping and is estimated as

$${t}_{*} = \frac{{( 2 l )}^{2}}{t \sqrt{E / {ρ}_{S}}} . \qquad ( 11 )$$

in which ρₛ denotes the material density.

### Servo-HCM Designing

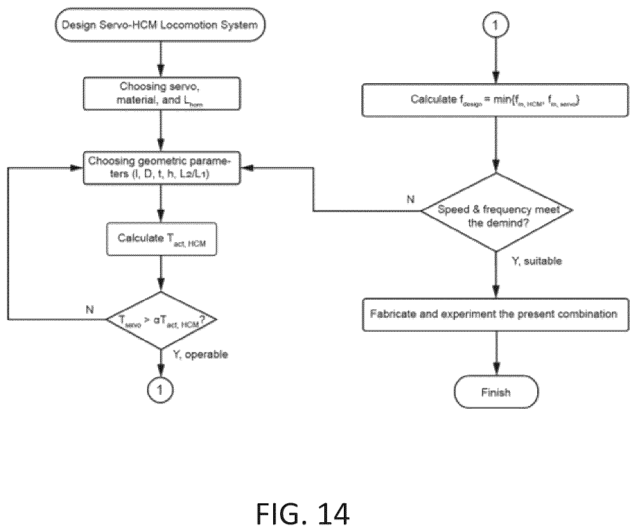

According to the HCM working principles, the algorithm for designing a servo-HCM locomotion system fish robots can be illustrated in FIG. 14. Usually, the most important and time-consuming procedure is to look for correct combinations of servo, material, and shapes, according to our experience with the two fish robots. Typical materials include plastic, CFRP, and steel sheets, whose related properties are given in Table I. These materials have high Young's modulus, tensile strength, and elastic strain limits. When they are in the form of sheets, their out-of-plane stiffness is usually smaller than their in-plane stiffness (membrane stiffness) by an order of 10⁵˜10⁶, making these 2D structures bendable and compliant. The information on common servo motors is provided in Table II, in which Tₛₑᵣᵥₒ denotes the stall torque of servo motors. A design factor of α>1 is suggested to ensure the successful servo-driven snap-through buckling of the HCM. Since the undulating frequency capacity is the most important parameter for a fish robot to achieve high speed, the present algorithm is to iterate the geometry for a satisfactory f_{design}.

TABLE I
Dimensions and mechanical properties of typical HCM materials

| Material | t (mm) | ρₛ (t/mm³) | E (MPa) | E/ρₛ (mJ/t) |
|---|---|---|---|---|
| PETG | 0.381, 0.762, | 1.25e−9 | 1.7e3 | 1.42e12 |
| CFRP | 0.5, 0.79 | 1.6e−9 | 64e3 | 40e12 |
| steel | 0.15, 0.5 | 7.8e−9 | 200e3 | 25e12 |

TABLE II
Specifications of common servo motors

| | Tₛₑᵣᵥₒ | speed | weight | Lₕₒᵣₙ | f_{m, servo} |
|---|---|---|---|---|---|
| | (mm · N) | (rad/s) | (g) | (mm) | (Hz) |
| MG90S | 245 | 10.5 | 14 | 10 | 4.5 |
| B24CLM | 588 | 12.3 | 22 | 20 | 6.15 |
| A66BHLW | 3234 | 15.4 | 66 | 25 | 13.6 |
| A06CLS | 294 | 20.1 | 7 | 13 | 17.0 |
| DS3230MG | 3381 | 6.16 | 58 | 25 | 3.08 |
| SG92R | 245 | 10.5 | 9 | 10 | 4.5 |
| ZOSKAY | 3430 | 9.5 | 60 | 25 | 4.76 |

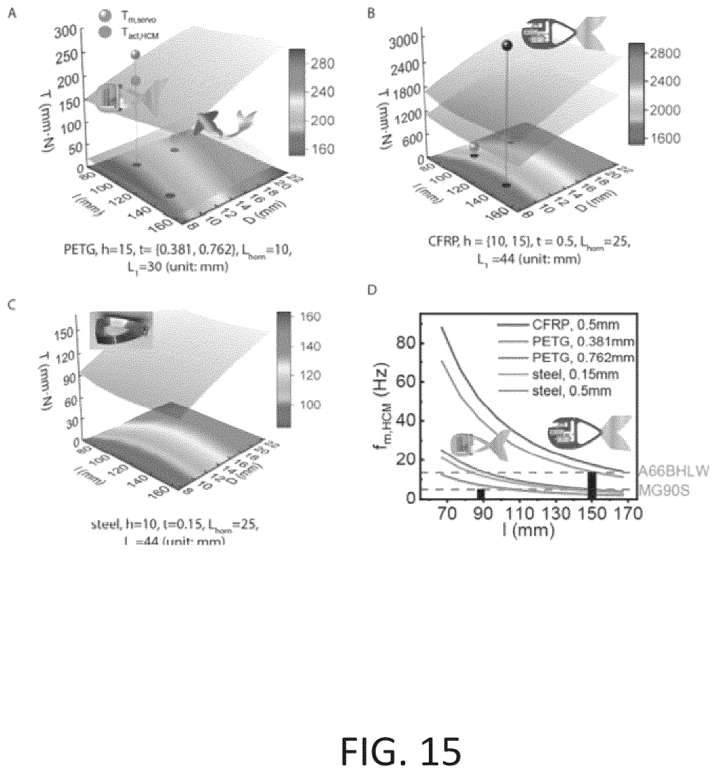

Based on the HCM theory, the influence of geometric parameters is illustrated in FIG. 15. Besides the material type and servo horn, dimensions (I, D, t, h, L₂/L₁) decide the required actuation torque T_{act, HCM} of HCMs. More specifically, we find T_{act, HCM} is proportional to D, h, and t³, and is less relevant to l since the increase of l not only decreases energy barrier U_{barr} but also decreases 2u(L₁), i.e., the required actuation displacement of HCM snap-through. FIG. 15, with the three prototypes embedded, is to validate the fabrication methodology and delineate the influence of geometric parameters. The pink fish is made from PETG HCM that has a geometry of (l, D, t, h, L₂/L₁)=(87.5, 17.1, 0.381, 15, 6) (unit: mm and 1), which corresponds to a required torque of T_{act, HCM}=28.3 mm N if using a servo motor to actuate; the coral fish robot has a shape of (l, D, t, h, L₂/L₁)=(87, 11.8, 0.762, 15, 1.9), corresponding to T_{act, HCM}=188.7 mm. N and thus a design factor α_{coral}=245/188.7=1.3 due to the use of an MG90S. Steel sheets have not been used yet but should have a similar effect on T_{act, HCM} as plotted in FIG. 15C when used with a servo horn of 25 mm (A66BHLW).

The frequency capacity analysis is demonstrated in FIG. 15D. According to Eq. (11), the f_{m, HCM}, is proportional to t and the reciprocal of l₂. However, the limiting condition is usually the speed of the servos, as in FIG. 15D. For example, the coral fish has a maximum HCM frequency of f_{m, HCM}=14.8 Hz, while the MG90S servo operates at a maximum of T_{m,servo}=4.5 Hz. Its actual achievable undulation frequency is 0˜ 4 Hz.

### Fabrication

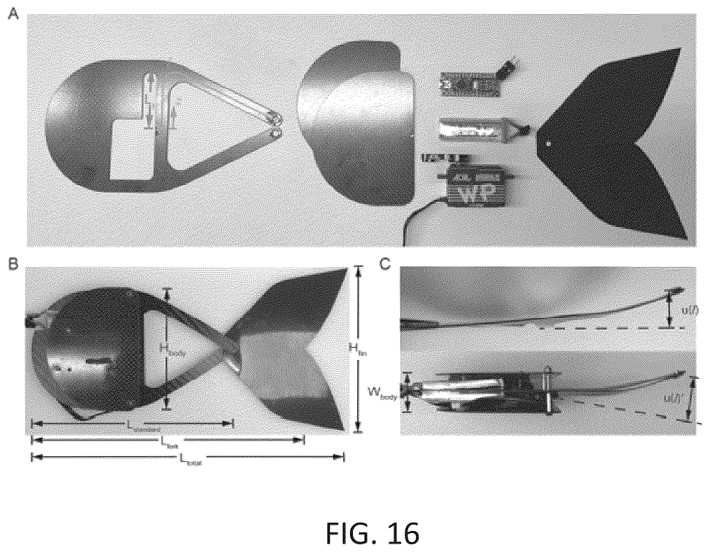

The HCM theory shows that the matrix material of HCMs plays a significant role in its performance. The timescale and the energy stored and released in each snapping are highly determined by Young's modulus of the material. Meanwhile, the repetitive snap-through buckling requires the material to be elastic and strong, which corresponds to the elastic limit and the strength of the material. CFRP sheets are well-known for their high modulus, yield strain, tensile strength, and light-weightedness, very promising to be an excellent component for HCM compliant robots. From TABLE I, CFRP has the highest specific Young's modulus E/ρₛ, which indicates its potential to generate a high frequency capacity f_{design}. Also, the thin thickness of CFRP can guarantee a low enough T_{act, HCM} for the successful snapping of HCMs. Thus, we fabricate CarbonFish with (I, D, t, h, L₂/L₁)=(137, 10, 0.5, 10, 2.1), which gives a design factor α_{carbon}=3234/1177=2.8 with A66BHLW as the driving servo (FIGS. 15B and 16). The components of CarbonFish are shown in photos of FIG. 16, with parameters body height H_{body}=100 mm, fin height H_{fin}=140 mm, Standard length L_{standard}=170 mm, fork length L_{fork}=232 mm, total length Lₜₒₜₐₗ=270 mm, and body width W_{body}=21 mm. Assuming the lateral displacement before the assembly of the fish u(l) equals the lateral displacement u′(l) afterward, their theoretical value is 36 mm from Eq. (7), and actual values are u(l)=25 mm≈u′(l). The deviation of the experiment from theory is due to the strengthening of the core area's (denoted by L₁) bending stiffness by the body plates. Limited by the speed of the servo used, CarbonFish has a theoretic frequency capacity of f_{design}=f_{m,servo}=13.6 Hz, and can achieve 10 Hz undulation with the prototype. To further increase the flapping frequency and swimming speed in the future, a DC motor-driven HCM system would be very beneficial due to the DC motor's high rotating speed.

The hydraulic friction of swimmers mainly consists of two parts: the resistance created by the pressure difference between the front and rear water, which is approximately proportional to the sectional area of the swimmer, and the resistance created by the boundary layer, which is approximately proportional to the surface area of the swimmer. In CarbonFish, most components are open to water flow to reduce the resistance from the sectional area. However, the waterproofing of these electronics would be a big challenge.

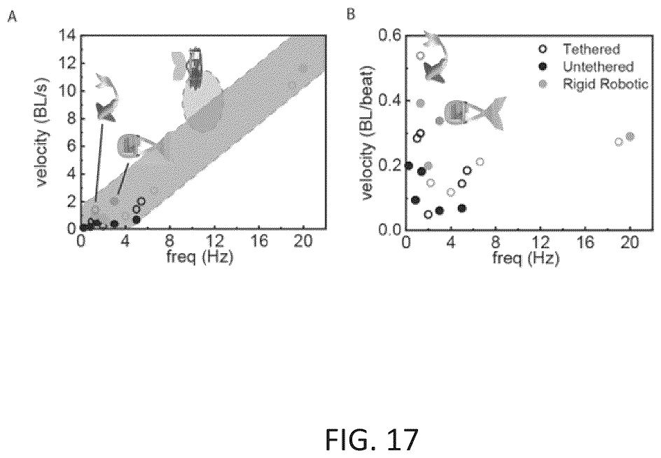

FIG. 17 compares our inventions with the existent fish robots, soft or rigid. Although the speed of HCM fish robots is not as high as the state-of-the-art ones, their velocities in body length per beat are very promising, ranging from 0.34˜ 0.54 BL/beat. Based on that, the 10-Hz-undulating CarbonFish is estimated to have a speed of 6.8˜ 10.8 BL/s, as shown in FIG. 17A, and has the potential to compete with real fish that swim in the range of 2˜ 10 BL/s.

### Conclusion

The research depicts the development and validation of the Hair Clip Mechanism (HCM) for application in soft robotic fish, specifically the CarbonFish model. The HCM, an in-plane prestressed bistable mechanism, has been shown to significantly enhance the structural rigidity and functional mobility of soft robotics compared to other soft robotic designs. Besides, the HCM's bistable nature allows for energy storage and release, which is harnessed to produce a novel undulation pattern that combines energy efficiency with high propulsion. The HCM's ability to function as a load-bearing skeleton, motion transmission system, and high-speed actuator is a testament to the versatility and potential of this mechanism in soft robotics.

The utilization of carbon fiber-reinforced plastic (CFRP) as the core material for the HCM has been a pivotal aspect of this study, contributing to the high-frequency undulatory capabilities of CarbonFish. The CarbonFish, with its single-actuated design, has demonstrated undulation frequencies of up to 10 Hz, indicating a potential to achieve swimming speeds that could rival or surpass those of real fish. The design and fabrication methodology, underpinned by mathematical modeling, has been critical in achieving these results.

Manuscript 7: Accelerate Soft Robots with the Aquatic HCM Effect

Fish swimming patterns have long fascinated researchers due to their efficiency, agility, and adaptability in aquatic environments. Related research dates back to the eel locomotion study performed 90 years ago. Modern investigation has shown that 85% of the fish species are Body and/or Caudal Fin (BCF) swimmers that undulate a fraction of their bodies to generate propulsion. Ordered by locomotion speed, BCF swimming is further divided into the diagrams of Ostraciiform, Anguilliform, Subcarangiform, and the fastest Thunniform. These swimming patterns have served as a rich source of inspiration for designing robotic systems that can navigate and interact with water-based environments.

On the other hand, BCF swimming is also the major locomotion pattern of soft aquatic robotic systems that use flexible and compliant materials to mimic natural movements and interact with the environment. This new type of fish robot has garnered significant attention due to its potential for safe interaction, economic viability, non-intrusive underwater exploration, and environmental monitoring. Unlike traditional propeller-driven underwater vehicles, soft fish robots usually use fluidic or electroactive polymer actuators to undulate the fish bodies. Marchese et al., Katzschmann et al., Marchese et al., and Katzschmann et al, present the design, fabrication, control, and oceanic testing of a self-contained soft robotic fish capable of rapid and continuum-body motion. The robot swims in three dimensions to monitor aquatic life closely. Li et al, and Li et al, design and fabricate a ray fish-inspired soft swimmer actuated by dielectric elastomer. The swimmer can locomote at high speed and sustain high water pressure in the Mariana Trench. Zhang et al, study global vision-based formation control of soft robotic fish swarm.

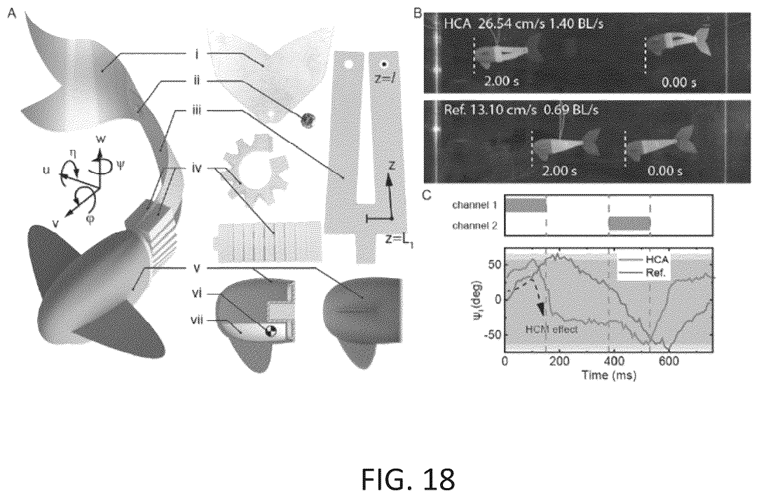

While soft robotic fish show great promise, they are plagued by low speeds. The highest speed soft swimmers achieve is 0.5˜ 0.7 BL/s, far from the 2-10 BL/s of organic fish. Some other soft swimmers may have faster speeds but are not adequate for an untethered situation. In our previous studies, a type of in-plane prestressed bi-stable hair-clip-like mechanism (HCM, FIG. 18A, iii) is proposed to improve the manipulation and locomotion ability of soft robotics. HCMs have elevated stiffness, simple structure, and energy-storing-and-releasing ability. Thus, they can simultaneously function as a structural chassis, motion transmission part, and force amplifier of a robotic system to improve its performance. Our study demonstrates that a pneumatic HCM fish robot can locomote twice as fast as the conventional fish robot (1.40 BL/s versus 0.69 BL/s, FIG. 18B) with the same energy input. Observation shows that the HCM body creates a special undulation pattern that we term HCM bi-stable swinging or HCM undulation (FIG. 18C).

According to the definition of propulsive efficiency

$${η}_{P} = FU / P \qquad ( 1 )$$

when the swimming speed is doubled, the swimming efficiency can be eight-folded if we assume fluidic resistance is proportional to the velocity squared,

$$F = friction μ {U}^{2} , \qquad ( 2 )$$

where U is the constant forward speed during steady cruising, P is the average input power, and F is the time-averaged force in the forward direction applied on the fish, which is assumed to equal the friction during steady cruising. Studying the unique HCM swimming pattern may provide insights into aquatic soft robotics, efficient underwater vehicles, novel bio-inspired locomotion patterns, etc.

In this work, a comparison of the HCM robot and traditional reference robot (addressed as reference robot, reference, or ref, below) is carried out based on experimental observations: the HCM method, pattern, and analytic solutions are briefly introduced and the aquatic HCM effect is presented in robotics research for the first time, as far as the authors are aware; we verify the HCM effect initially via a simulated single-link undulation and point out the future directions of simulating HCM fish robots.

### HCM Swimming Pattern

The experiments are carried out on a pair of pneumatic fish robots with and without HCM (FIG. 18). Both use external energy sources, have a pair of antagonistic bending units as the actuation method, and have the same length and self-weight (18.6 cm and 42.5 g). To ensure the same amount of energy consumption, they have the same actuation pressure and duty cycle percentages, as shown in FIG. 18C. It is noted that the HCM modulates the near-sinusoidal swinging of the caudal fin into a novel swinging pattern due to its energy-storing and -releasing mechanism. The working principles of the HCM fish robot are described below. Initially, the zero-pressure shape of the HCM is a curved one. When the pneumatic bending unit of the left side (without losing generality) of the fish is active, the HCM starts to build up elastic energy, during which the HCM body and caudal fin bend further to the left. But after a certain pressure level or bending displacement, the HCM releases all its elastic energy accumulated in the previous stage, snapping rapidly to the right and creating an angular speed ˜3 times faster (1200 vs 340°/s) than the reference fish robot. Since the aquatic reaction force is proportional to the velocity squared, HCM undulation ameliorates the swimming efficiency, providing a two-fold speed increase without complicating the robotic design or consuming more energy. The HCM can likewise be configured to effectuate travel or passage through other fluids as well. For example, one or more HCM can be configured to effectuate travel through air, such as a pair of HCM causing synchronized motion.

### HCM Analytic Solutions

Our previous modeling, derivation, and verification have shown that the lateral-torsional buckling accompanies the prestressing process of beams and ribbons. Since the out-of-plane bending moment and rotating torque contribute the most to thin wall beam deformation and the latter is small, we can assume the angled ribbon is straight to simplify the mathematical modeling. With the small deflection assumption, we can depict the angular displacement (FIG. 18A) of a cross section on HCM as

$$φ ( z ) = \frac{d u}{d z} = \sqrt{l - z} {A}_{1} {J}_{1 / 4} ( \frac{1}{2} \sqrt{\frac{{P}_{{cr}^{2}}}{{EI}_{η} C}} {( l - z )}^{2} ) , \qquad ( 3 )$$

in which z is the coordinate along the path of the ribbon (FIG. 18A), u or u(z) is the lateral displacement (swaying) of the cross-section, l is the half ribbon length, A₁ is a non-zero integration constant that can be determined from energy conservation, J_{1/4} is the Bessel function of the first kind of order ¼, EI_{η} is the out-of-plane bending stiffness of the ribbon, C is the torsional rigidity of the cross-section, E is the Young's modulus, and P_{cr} is the critical load of the lateral-torsional buckling expressed as

$${P}_{c r} = \frac{5.5618}{{l}^{2}} \cdot \sqrt{{EI}_{η} C} . \qquad ( 4 )$$

From Eq. (1), the lateral displacement of the cross section can be approximated as

$$u ( z ) = {\int }_{0}^{z} φ ( s ) ds . \qquad ( 5 )$$

### HCM Effect Simulation

To study the aquatic HCM effect, we simulate a single-link model of the caudal fin using Aquarium. Aquarium is an open-source, physics-based, fluid-structure interaction solver for robotics that offers stable simulation of the coupled fluid-robot physics in 2D. Specifically, Aquarium simulates the fluid dynamics directly over the normalized Navier-Stokes equations for incompressible, Newtonian fluids (e.g., water). The immersed boundary method is then used to couple the fluid dynamics with a solid body (e.g., BCF), which additionally allows for the calculation of fluid forces acting along the body's surface. The fluid forces acting along the swimming direction are then summed to calculate the net thrust. We refer the reader to the existing literature for more details of Aquarium's implementation.

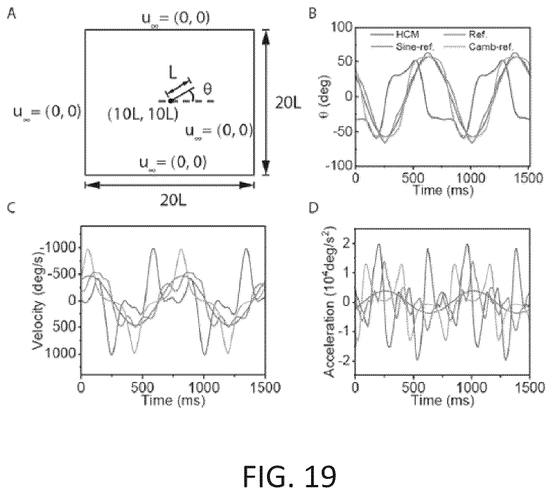

The simulation is set in a 2D box with zero-velocity boundary conditions, as shown in FIG. 19A). A swinging rigid link with length L=12 cm is used to replicate the BCF undulation of the fish robots in FIG. 18. FIG. 19B shows the smoothed peduncle swinging of the HCM fish and the reference from FIG. 18C and is used as the simulation input. It is reported in the elongated-body theory that a traveling wave can describe the cruising of fish

$$h ( x , t ) = g ( x ) sin ( k x + ω t ) \qquad ( 6 )$$

in which h (x, t) is the lateral displacement from the stretched straight position, x is the coordinate downstream from the nose of the straightened fish, g(x) is the amplitude function, k is the body wave number, and @ is the body wave frequency. Besides, Xie et al. demonstrate that natural fish use sinusoidal body wave for a higher swimming efficiency, but cambering sinusoidal body wave has higher thrust than sinusoidal one. To broaden the search for the best swimming pattern, we include in the simulation (FIG. 19B) a curve-fit sine wave based on the smoothed peduncle undulation of the reference robot and a cambering wave that is expressed as

$${θ}_{c a m b e r i n g} = \frac{m tanh ( B {θ}_{s i n e} )}{tanh ( B )} , \qquad ( 7 )$$

where B>0 is the shape control factor, and θi is the undulation angle of the link of the patterns. The cambering wave will have the same amplitude as the sine wave but a higher peak speed, as shown in FIG. 19C. Increasing B leads to increasing cambering-ness, and moving B towards zero reduces Eq. (7) to a sine wave. In this work, we take B=2 so that the peak velocity of the cambering swing can match that of the HCM. The HCM undulation has the highest peak acceleration among the four patterns, about 20000 deg/s² (vs. 14000, 4000, and 13000 deg/s² for the other three), shown in FIG. 19D. A passage of four cycles (˜3s, T=760 ms) is simulated.

### Results

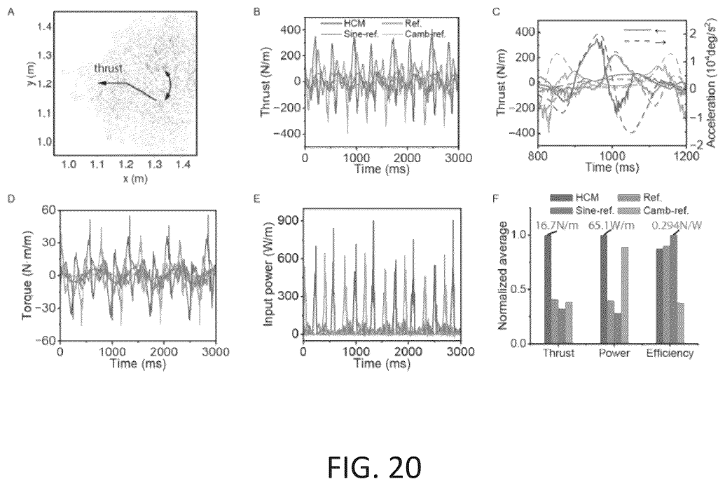

FIGS. 20A and 20B show the vorticity and the recorded thrust, respectively. We note that the thrust is positively or negatively correlated with the acceleration in an alternative pattern, as shown by a half period of positive correlation in FIG. 20C. This phenomenon can be attributed to the fact that a certain fraction of the fluidic volume at the fish's rear has the same velocity as the swinging fin, which means only the change of velocity, i.e., the acceleration, of the fin pushes against this volume and provides thrust. The alternation is due to the time and geometric symmetry.

FIG. 20D is the torque the link experiences during the four types of undulation, and the input power in FIG. 20E is obtained by multiplying the torque by the angular velocities in FIG. 19C, with negative values removed since the robotic system doesn't collect energy. Integrating the instant thrust and power provides the average thrust, the average power, and the energy efficiencies shown as absolute and normalized values in FIG. 20F, with normalization factors being their respective maxima.

The comparison demonstrates that the sine wave has the highest energy efficiency for steady cruising, consistent with natural selection. However, the results also indicate that the sine wave undulation may be the worst in generating thrust and achieving high speeds. Xie et al, and Gao et al, also noticed the better performance of modified sine waves (i.e., cambering sine waves) compared to the ideal sine wave under the same frequency. Xie et al, assumed that the sine wave is adopted by nature over the cambering sine wave because the latter produces a larger recoil and has a lower energy efficiency, indicated by a worse Strouhal Number (SN). Gao et al, achieved a similar conclusion based on the calculation results that the larger thrust of the cambering sine wave is based on an even larger energy input, which corresponds to the results of this work that the cambering sine wave generates more thrust but has a much lower energy efficiency.

On the other hand, fish also use strikes with high velocity and acceleration to generate a large thrust or speed, as is needed during behaviors like hunting and escaping. The HCM bi-stable undulation generates three times more thrust than the sine wave at the same frequency (1.3 Hz) and 87% of the sine wave efficiency, which shows the HCM undulation's potential for the fish or bionic fish robot during high-speed swimming, especially when HCM simplifies the robotic systems.

Sánchez-Caja et al, proposed that the optimal propulsion solution may lie beyond the scope of living organisms because they have living-body constraints that human inventions are not subject to. Our previous work indicates that the HCM snapping introduces higher stress and strain detrimental to living tissues, which can explain why the HCM undulation is rarely used by nature except in very few cases. However, the novel HCM undulation pattern may be a competitive propelling strategy for aquatic soft robots and bionic underwater vehicles under the abovementioned situations.

### Outlook

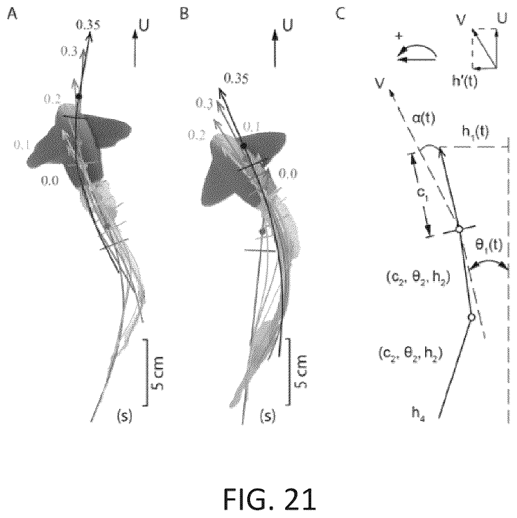

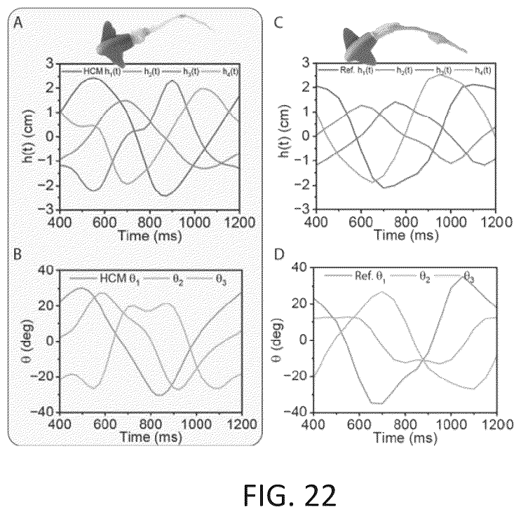

Due to the lack of comprehensive swimming modeling, the single-link results are still limited and subject to modeling errors and approximations. Therefore, we propose a sampling method for a future multi-link simulation based on the pneumatic fish robots' swimming footage, as shown in FIG. 21. FIGS. 21A and 21B illustrate the configuration evolution of the fish bodies during the HCM and reference swimming, respectively, and the sampled data is shown in FIG. 22.

While the characteristic variables on the anterior portion of the HCM fish (h₁, h₂, and θ₁) show sinusoidal features, the posterior portion (h₃, h₄, and θ₃) presents nonlinearity like cambering, skewness, and asymmetry. These properties correspond to the working principle of HCMs since they build up elastic energy in their “core” area (z≤L₁, FIG. 18A) and transmit and release the energy toward their far end (z→L₁), using the tapering tips as end effectors. On the other hand, the variables of the reference model follow a sine wave pattern. The multi-link scenario can function as a better efficiency comparison of different propulsive patterns and provide baselines for optimizing these locomotion patterns.

### Conclusion

For the first time, we introduce the hair clip mechanism (HCM) undulation resulting from the snap-through buckling of HCMs, a kind of in-plane prestressed mechanism, and demonstrate the higher thrust gained by HCM undulation that we call the aquatic HCM effect. When using an HCM as a robotic propeller of a soft fish robot, the experiment shows a two-fold faster cruising speed (26.54 vs. 13.10 cm/s) than the reference design. A corresponding reduced single-link swinging simulation using Aquarium, a 2D aquatic solver, is conducted to replicate and verify the HCM effect. Results show that the HCM undulation generates 2-3 times more aquatic thrust (16.7 N/m) than the traced reference pattern (6.78 N/m), curve-fit sine pattern (5.34 N/m), and cambering sine pattern (6.36 N/m) and have an energy efficiency 87% of the ideal sine wave. The initial analyses support the assumption that HCM undulation can be a strategy when high-speed swimming or a simpler design is wanted. Meanwhile, a multi-link simulation method is proposed to help verify the effect in the future.

This work on the novel HCM undulation and aquatic HCM effect may help improve the function of future soft robots, underwater vehicles, and extreme-environment explorers.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated=10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### Aspects

The following Aspects are illustrative only and do not limit the scope of the present disclosure or the appended claims. Any part or parts of any one or more Aspects can be combined with any part or parts of any one or more other Aspects.

Aspect 1. A bistable component, comprising: a ribbon comprising (i) a first extension arm having a proximal portion and a distal portion, (ii) a second extension arm having a proximal portion and a distal portion, and (iii) a central segment connecting the proximal portion of the first extension arm and the proximal portion of the second extension arm, the distal portion of the first extension arm being joined to the distal portion of the second extension arm at a joint, the bistable component being reversibly convertible between a stable stressed first state and a stable stressed second state, the central segment having (i) a first curvature state corresponding to the bistable component being in the stable stressed first state and (ii) a second curvature state corresponding to the bistable component being in the stable stressed second state, and inversion of the central segment from one of the first curvature state and the second curvature state to the other of the first curvature state and the second curvature state effecting conversion of the bistable component from the respective one of the first stressed stable state and the second stressed stable state to the other of the first stressed stable state and the second stressed stable state.

The component can be formed of, e.g., metal, plastic, paper, or any combination thereof. Metal components are considered particularly suitable, but metal is not a requirement.

Aspect 2. The bistable component of Aspect 1, wherein the central segment is translated by a distance D during inversion, and wherein the joint is translated by a distance greater than D during inversion.

Aspect 3. The bistable component of any one of Aspects 1-2, wherein a point on the central segment rotates by an angle θ during inversion, and wherein the joint rotates by an angle greater than θ during inversion.

Aspect 4. The bistable component of any one of Aspects 1-3, wherein the bistable component is comprised in any one or more of a gripper, a robot, a drone, a vehicle, or any combination thereof.

Aspect 5. The bistable component of any one of Aspects 1-4, wherein the first extension arm and the second extension arm are rotatable about the joint.

Aspect 6. A method, comprising effecting conversion of a bistable component according to any one of Aspects 1-5 between one of the stable stressed first state and the stable stressed second state and the other of the stable stressed first state and the stable stressed second state.

Aspect 7. A system, the system comprising a bistable component according to any one of Aspects 1-5 and an actuator, the actuator configured to effect inversion of the central segment from one of the first curvature state and the second curvature state to the other of the first curvature state and the second curvature state.

Aspect 8. The system of Aspect 7, wherein the system is comprised in a gripper, a robot, a drone, a vehicle, or any combination thereof.

Aspect 9). The system of Aspect 8, wherein the system is comprised in a gripper.

Aspect 10. The system of Aspect 7, wherein the system is comprised in a robot.

What is claimed:

1. A bistable component, comprising:
a ribbon comprising (i) a first extension arm having a proximal portion and a distal portion, (ii) a second extension arm having a proximal portion and a distal portion, and (iii) a central segment connecting the proximal portion of the first extension arm and the proximal portion of the second extension arm,
the distal portion of the first extension arm being joined to the distal portion of the second extension arm at a joint,
the bistable component being reversibly convertible between a stable stressed first state and a stable stressed second state,
the central segment having (i) a first curvature state corresponding to the bistable component being in the stable stressed first state and (ii) a second curvature state corresponding to the bistable component being in the stable stressed second state, and
inversion of the central segment from one of the first curvature state and the second curvature state to the other of the first curvature state and the second curvature state effecting conversion of the bistable component from the respective one of the first stressed stable state and the second stressed stable state to the other of the first stressed stable state and the second stressed stable state.

2. The bistable component of claim 1, wherein the central segment is translated by a distance D during inversion, and wherein the joint is translated by a distance greater than D during inversion.

3. The bistable component of claim 1, wherein a point on the central segment rotates by an angle θ during inversion, and wherein the joint rotates by an angle greater than θ during inversion.

4. The bistable component of claim 1, wherein the bistable component is comprised in any one or more of a gripper, a robot, a drone, a vehicle, or any combination thereof.

5. The bistable component of claim 1, wherein the first extension arm and the second extension arm are rotatable about the joint.

6. A method, comprising effecting conversion of a bistable component according to claim 1 between one of the stable stressed first state and the stable stressed second state and the other of the stable stressed first state and the stable stressed second state.

7. A system, the system comprising a bistable component according to claim 1 and an actuator, the actuator configured to effect inversion of the central segment from one of the first curvature state and the second curvature state to the other of the first curvature state and the second curvature state.

8. The system of claim 7, wherein the system is comprised in a gripper, a robot, a drone, or any combination thereof.

9. The system of claim 8, wherein the system is comprised in a gripper.

10. The system of claim 7, wherein the system is comprised in a robot.
